(19) United States
(12) Patent Application Publication
(10) Pub. No.: US 2026/0036794 A1
(43) Pub. Date: Feb. 5, 2026

(54) IMAGING OPTICAL SYSTEM, AND IMAGE CAPTURE DEVICE AND CAMERA SYSTEM INCLUDING THE SAME

(71) Applicant: Panasonic Intellectual Property Management Co., Ltd., Osaka (JP)

(72) Inventors: Emiri SUZUKI, Osaka (JP); Naoto Nishimura, Osaka (JP)

(21) Appl. No.: 19/272,642

(22) Filed: Jul. 17, 2025

(30) Foreign Application Priority Data
Jul. 31, 2024 (JP) 2024-125127

(51) Int. Cl. G02B 13/00; G02B 7/02; G02B 15/14; G03B 17/14; H04N 23/55

(52) U.S. Cl. CPC G02B 13/009; G02B 7/025; G02B 13/0045; G02B 13/006; G02B 15/1461; G03B 17/14; H04N 23/55

(57) ABSTRACT

An imaging optical system consists of: a first lens group having positive power; a second lens group having negative power; an aperture stop; a third lens group having positive power; a fourth lens group having positive power; a fifth lens group having negative power; and a rear lens group including at least one lens groups having power, where the first lens group is closest to an object. An interval between adjacent lens groups changes while the optical system is zooming from a wide-angle end toward a telephoto end. The fifth lens group consists of two negative meniscus lenses with convex surfaces facing the object and the image plane, respectively. The fifth lens group moves from the object toward the image plane while the optical system is focusing to make a transition from an infinity in-focus state toward a close-object in-focus state.

### CROSS-REFERENCE TO RELATED APPLICATIONS

The present application is based upon, and claims the benefit of priority to, Japanese Patent Application No. 2024-125127, filed on Jul. 31, 2024, the entire contents of which are hereby incorporated by reference.

### TECHNICAL FIELD

The present disclosure relates to an imaging optical system having the ability to compensate for various types of aberrations sufficiently over the entire zoom range and also relates to an image capture device and camera system including such an imaging optical system.

### BACKGROUND ART

JP 2020-118738 A discloses a zoom lens system including a first lens group having positive power, a second lens group having negative power, a third lens group having positive power, a fourth lens group having negative power, a fifth lens group having positive power, and a sixth lens group having negative power. The first, second, third, fourth, fifth, and sixth lens groups are arranged in this order such that the first lens group is located closer to an object than any of the other second, third, fourth, fifth, and sixth lens groups is, and that the sixth lens group is located closer to an image plane than any of the other first, second, third, fourth, and fifth lens groups is.

### SUMMARY

The present disclosure provides an imaging optical system having the ability to compensate for various types of aberrations sufficiently over the entire zoom range and an image capture device and camera system including such an imaging optical system.

An imaging optical system according to an aspect of the present disclosure consists of: a first lens group having positive power; a second lens group having negative power; an aperture stop; a third lens group having positive power; a fourth lens group having positive power; a fifth lens group having negative power; and a rear lens group including one or more lens groups each having power. The first lens group, the second lens group, the aperture stop, the third lens group, the fourth lens group, the fifth lens group, and the rear lens group are arranged in this order such that the first lens group is located closer to an object than the second lens group, the aperture stop, the third lens group, the fourth lens group, the fifth lens group, or the rear lens group is, and that the rear lens group is located closer to an image plane than the first lens group, the second lens group, the aperture stop, the third lens group, the fourth lens group, or the fifth lens group is. An interval between two adjacent ones of the first, second, third, fourth, and fifth lens groups and the one or more lens groups of the rear lens group changes while the imaging optical system is zooming from a wide-angle end toward a telephoto end. The fifth lens group consists of: a first negative meniscus lens having a convex surface facing the object; and a second negative meniscus lens having a convex surface facing the image plane. The first negative meniscus lens and the second negative meniscus lens are arranged in this order such that the first negative meniscus lens is located closer to the object than the second negative meniscus lens is and that the second negative meniscus lens is located closer to the image plane than the first negative meniscus lens is. The fifth lens group moves in a direction pointing from the object toward the image plane while the imaging optical system is focusing to make a transition from an infinity in-focus state toward a close-object in-focus state.

A camera system according to another aspect of the present disclosure includes: an interchangeable lens unit including the imaging optical system described above; and a camera body including: an image sensor configured to receive an optical image of an object formed by the imaging optical system and transform the optical image into an electrical image signal; and a camera mount. The camera body is configured to be connected removably to the interchangeable lens unit via the camera mount. The interchangeable lens unit is configured to form the optical image of the object on the image sensor.

An image capture device according to still another aspect of the present disclosure is configured to transform an optical image of an object into an electrical image signal and display and/or store the electrical image signal thus transformed. The image capture device includes: the imaging optical system configured to form the optical image of the object; and an image sensor configured to transform the optical image formed by the imaging optical system into the electrical image signal.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1A illustrates lens arrangements showing an infinity in-focus state of an imaging optical system according to a first embodiment (corresponding to a first example of numerical values);

FIG. 1B illustrates longitudinal aberration diagrams showing the infinity in-focus state of the imaging optical system in the first example of numerical values;

FIG. 2A illustrates lens arrangements showing an infinity in-focus state of an imaging optical system according to a second embodiment (corresponding to a second example of numerical values);

FIG. 2B illustrates longitudinal aberration diagrams showing the infinity in-focus state of the imaging optical system in the second example of numerical values;

FIG. 3A illustrates lens arrangements showing an infinity in-focus state of an imaging optical system according to a third embodiment (corresponding to a third example of numerical values);

FIG. 3B illustrates longitudinal aberration diagrams showing the infinity in-focus state of the imaging optical system in the third example of numerical values;

FIG. 4A illustrates lens arrangements showing an infinity in-focus state of an imaging optical system according to a fourth embodiment (corresponding to a fourth example of numerical values);

FIG. 4B illustrates longitudinal aberration diagrams showing the infinity in-focus state of the imaging optical system in the fourth example of numerical values;

FIG. 5A illustrates lens arrangements showing an infinity in-focus state of an imaging optical system according to a fifth embodiment (corresponding to a fifth example of numerical values);

FIG. 5B illustrates longitudinal aberration diagrams showing the infinity in-focus state of the imaging optical system in the fifth example of numerical values;

FIG. 6 illustrates a schematic configuration for an image capture device according to the first embodiment; and

FIG. 7 illustrates a schematic configuration for a camera system according to the first embodiment.

### DETAILED DESCRIPTION

Embodiments of the present disclosure will now be described in detail with reference to the accompanying drawings as needed. Note that unnecessarily detailed description will be omitted. For example, detailed description of already well-known matters and redundant description of substantially the same configuration will be omitted. This is done to avoid making the following description overly redundant and thereby help one of ordinary skill in the art understand the present disclosure easily.

In addition, note that the accompanying drawings and the following description are provided to help one of ordinary skill in the art understand the present disclosure fully and should not be construed as limiting the scope of the present disclosure, which is defined by the appended claims.

### First to fifth embodiments

Imaging optical systems according to first to fifth embodiments will now be described on an individual basis with reference to the accompanying drawings.

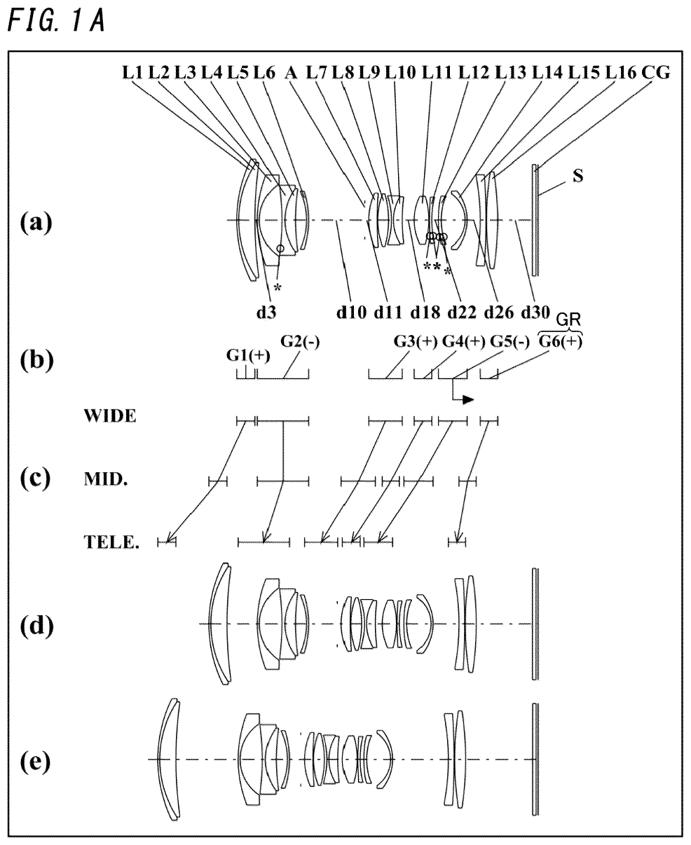

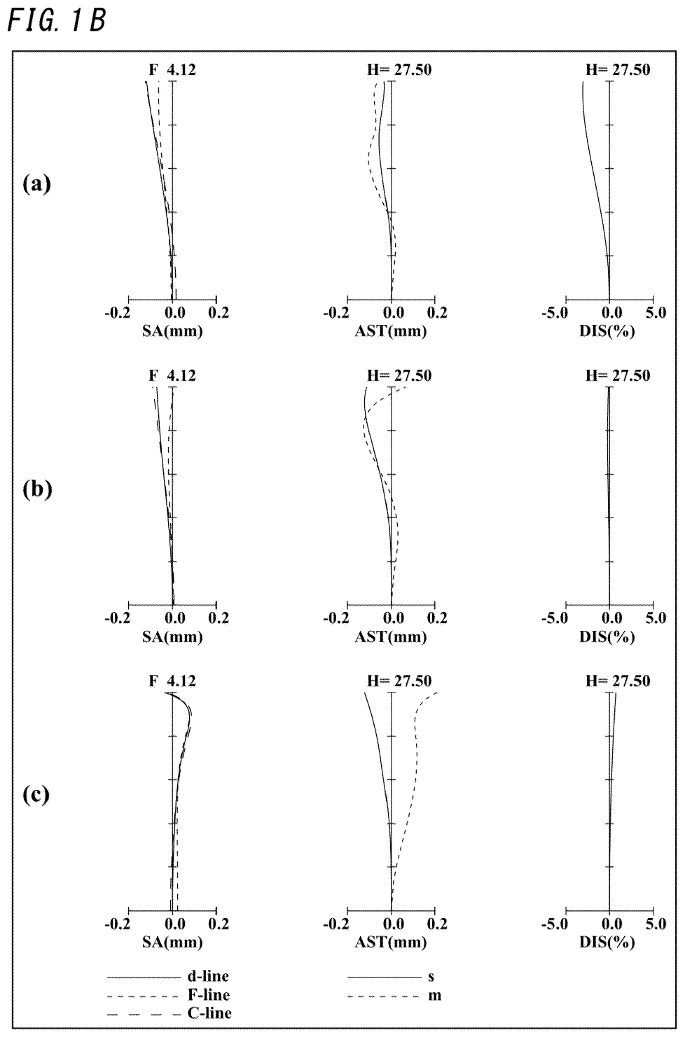

FIGS. 1A, 2A, 3A, 4A, and 5A illustrate lens arrangements of imaging optical systems according to the first to fifth embodiments, respectively. In each of FIGS. 1A, 2A, 3A, 4A, and 5A, the imaging optical system is in an infinity in-focus state.

In FIGS. 1A, 2A, 3A, 4A, and 5A, portion (a) illustrates a lens arrangement at a wide-angle end (which is a state with the shortest focal length fW); portion (d) illustrates a lens arrangement at a middle position (which is a state with a middle focal length fM=√(fW*fT)); and portion (e) illustrates a lens arrangement at a telephoto end (which is a state with the longest focal length fT). Note that portions (a), (d), and (e) of FIGS. 1A, 2A, 3A, 4A, and 5A have the same aspect ratio.

Furthermore, in portion (a) of FIGS. 1A, 2A, 3A, 4A, and 5A, the asterisk (*) attached to a surface of a particular lens indicates that the surface is an aspheric surface. Note that in the lenses shown in portion (a) of FIGS. 1A, 2A, 3A, 4A, and 5A, an object-side surface or an image-side surface having no asterisks is a spherical surface.

Also, in FIGS. 1A, 2A, 3A, 4A, and 5A, the polygon arrows shown in portion (c) thereof each connect together the respective positions of the lens groups at the wide-angle end (WIDE), middle position (MID), and telephoto end (TELE) from top to bottom. Note that these polygon arrows just connect the wide-angle end to the middle position and the middle position to the telephoto end with the lines, and do not indicate the actual movement of the lens groups.

Furthermore, in portion (b) of FIGS. 1A, 2A, 3A, 4A, and 5A, the respective lens groups are designated by the reference signs G1-G6 (or G1-G7) corresponding to their respective positions shown in portion (a).

Furthermore, the signs (+) and (−) added to the reference signs G1-G7 of the respective lens groups in portion (b) of FIGS. 1A, 2A, 3A, 4A, and 5A indicate the powers of the respective lens groups G1-G7. That is to say, the positive sign (+) indicates positive power, and the negative sign (−) indicates negative power.

Also, the arrows added to the lens groups in portion (b) of FIGS. 1A, 2A, 3A, 4A, and 5A each indicate focusing to make a transition from the infinity in-focus state toward the close-object in-focus state. Note that in FIGS. 1A, 2A, 3A, 4A, and 5A, the reference signs of respective lens groups are shown under the respective lens groups in portion (a) thereof, and therefore, an arrow indicating focusing is shown under the sign of each lens group for convenience's sake. In each zooming state, the directions of movement of the respective lens groups during focusing will be described more specifically later with respect to each of the first through fifth embodiments.

Furthermore, in portions (a), (d), and (e) of FIGS. 1A, 2A, 3A, 4A, and 5A, the straight line drawn at the right end indicates the position of the image plane S (i.e., a surface, facing the object, of the image sensor). Therefore, the left end of the drawings corresponds to the object side. Furthermore, a parallel plate such as a low-pass filter or cover glass CG is disposed between the lens group on the last stage, facing the image plane S, of the imaging optical system and the image plane S.

Note that the “optical axis” as used herein refers to the “optical axis of the imaging optical system” unless otherwise stated.

### First Embodiment

FIG. 1A illustrates an imaging optical system according to a first embodiment.

The imaging optical system is made up of: a first lens group G1 having positive power; a second lens group G2 having negative power; an aperture stop A; a third lens group G3 having positive power; a fourth lens group G4 having positive power; a fifth lens group G5 having negative power; and a sixth lens group G6 having positive power. The first lens group G1, the second lens group G2, the aperture stop A, the third lens group G3, the fourth lens group G4, the fifth lens group G5, and the sixth lens group G6 are arranged in this order such that the first lens group G1 is located closer to an object than any other member of this imaging optical system is, and that the sixth lens group G6 is located closer to an image plane than any other member of this imaging optical system is. The sixth lens group G6 is an example of a rear lens group GR.

The imaging optical system forms an image at a point on the image plane S.

The first lens group G1 is made up of a first lens L1 having negative power and a second lens L2 having positive power. The first lens L1 and the second lens L2 are arranged in this order such that the first lens L1 is located closer to the object than the second lens L2 is and that the second lens L2 is located closer to the image plane than the first lens L1 is. The first lens L1 and the second lens L2 are bonded together with an adhesive, for example, to form a bonded lens.

The second lens group G2 is made up of: a third lens L3 having negative power; a fourth lens L4 having negative power; a fifth lens L5 having positive power; and a sixth lens L6 having negative power. The third lens L3, the fourth lens L4, the fifth lens L5, and the sixth lens L6 are arranged in this order such that the third lens L3 is located closer to the object than any other member of this second lens group G2 is and that the sixth lens L6 is located closer to the image plane than any other member of this second lens group G2 is. The fourth lens L4 and the fifth lens L5 are bonded together with an adhesive, for example, to form a bonded lens.

The third lens group G3 is made up of: a seventh lens L7 having positive power; an eighth lens L8 having positive power; a ninth lens L9 having negative power; and a tenth lens L10 having positive power. The ninth lens L9 and the tenth lens L10 are bonded together with an adhesive, for example, to form a bonded lens.

The fourth lens group G4 is made up of an eleventh lens L11 having positive power and a twelfth lens L12 having negative power.

The fifth lens group G5 is made up of a thirteenth lens L13 having negative power and a fourteenth lens L14 having negative power.

The sixth lens group G6 is made up of a fifteenth lens L15 having negative power and a sixteenth lens L16 having positive power.

The respective lenses will be described.

First, the respective lenses that form the first lens group G1 will be described. The first lens L1 is a meniscus lens having a convex surface facing the object. The second lens L2 is a meniscus lens having a convex surface facing the object.

Next, the respective lenses that form the second lens group G2 will be described. The third lens L3 is a meniscus lens having a convex surface facing the object. The fourth lens L4 is a biconcave lens. The object-side surface of the fourth lens L4 has an aspheric shape. The fifth lens L5 is a meniscus lens having a convex surface facing the object. The sixth lens L6 is a meniscus lens having a convex surface facing the image plane.

Next, the respective lenses that form the third lens group G3 will be described. The seventh lens L7 is a meniscus lens having a convex surface facing the object. The eighth lens L8 is a biconvex lens. The ninth lens L9 is a biconcave lens. The tenth lens L10 is a meniscus lens having a convex surface facing the object.

Next, the respective lenses that form the fourth lens group G4 will be described. The eleventh lens L11 is a biconvex lens. The twelfth lens L12 is a meniscus lens having a convex surface facing the object. Both surfaces of the twelfth lens L12 have an aspheric shape.

Next, the respective lenses that form the fifth lens group G5 will be described. The thirteenth lens L13 is a meniscus lens having a convex surface facing the object. Both surfaces of the thirteenth lens L13 have an aspheric shape. The fourteenth lens L14 is a meniscus lens having a convex surface facing the image plane.

Next, the respective lenses that form the sixth lens group G6 will be described. The fifteenth lens L15 is a meniscus lens having a convex surface facing the image plane. The sixteenth lens L16 is a biconvex lens.

While the imaging optical system according to the first embodiment is zooming from the wide-angle end toward the telephoto end during a shooting session, the first lens group G1, the second lens group G2, the third lens group G3, the fourth lens group G4, the fifth lens group G5, and the sixth lens group G6 all move with respect to the image plane S. In the meantime, as the imaging optical system is zooming from the wide-angle end toward the telephoto end during the shooting session, the first, second, third, fourth, fifth, and sixth lens groups G1-G6 move along the optical axis such that the interval between the first lens group G1 and the second lens group G2 increases, the interval between the second lens group G2 and the third lens group G3 decreases, the interval between the third lens group G3 and the fourth lens group G4 decreases, the interval between the fourth lens group G4 and the fifth lens group G5 decreases, the interval between the fifth lens group G5 and the sixth lens group G6 increases, and the interval between the sixth lens group G6 and the image plane S increases,

While the imaging optical system according to the first embodiment is focusing to make a transition from the infinity in-focus state to the close-object in-focus state, the fifth lens group G5 moves along the optical axis toward the image plane.

### Second Embodiment

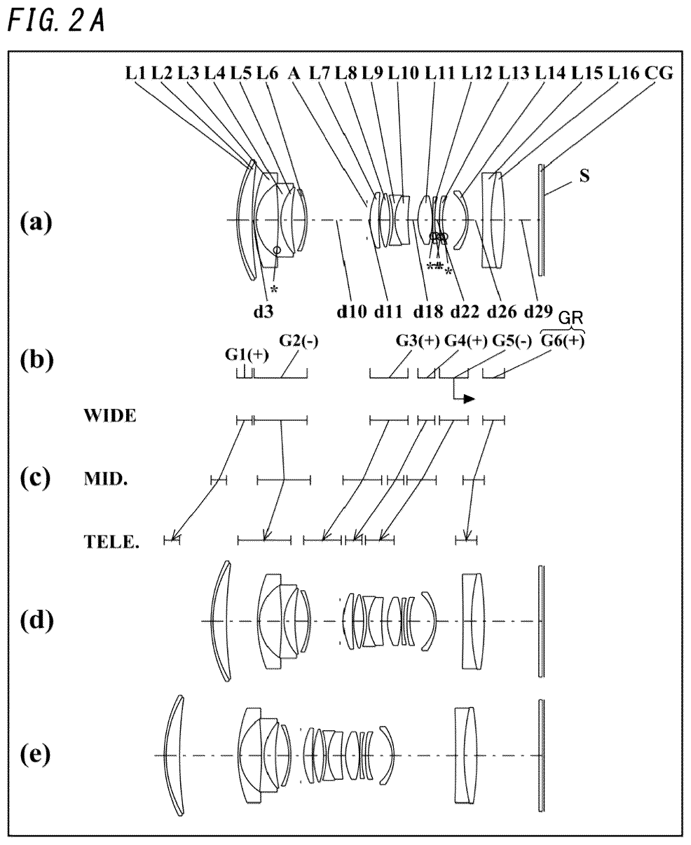

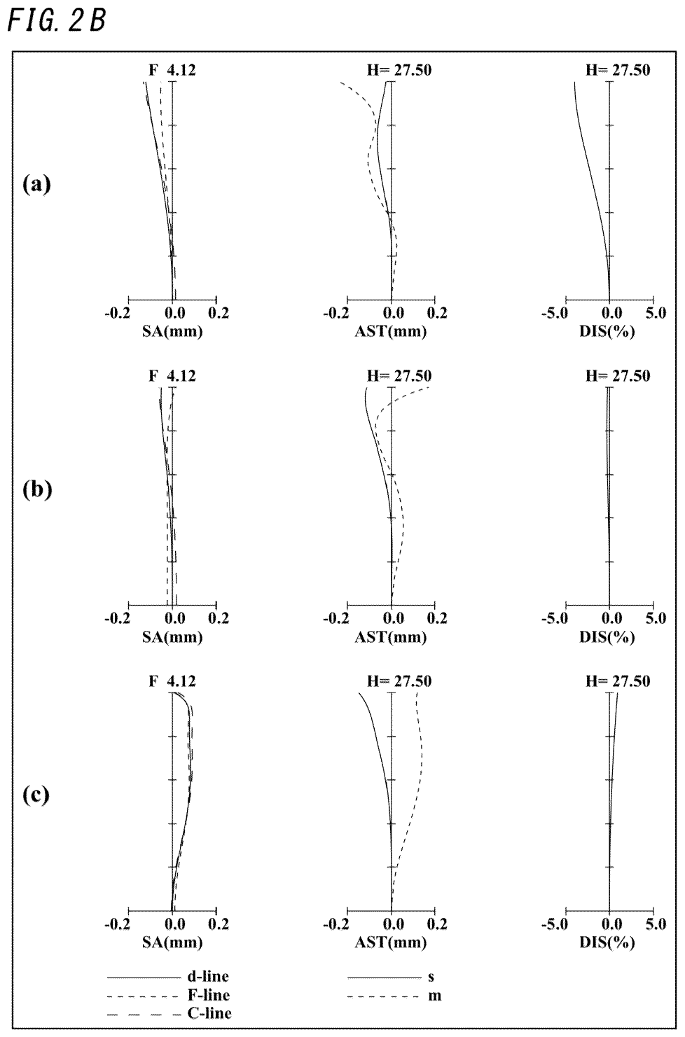

FIG. 2A illustrates an imaging optical system according to a second embodiment.

The imaging optical system is made up of: a first lens group G1 having positive power; a second lens group G2 having negative power; an aperture stop A; a third lens group G3 having positive power; a fourth lens group G4 having positive power; a fifth lens group G5 having negative power; and a sixth lens group G6 having positive power. The first lens group G1, the second lens group G2, the aperture stop A, the third lens group G3, the fourth lens group G4, the fifth lens group G5, and the sixth lens group G6 are arranged in this order such that the first lens group G1 is located closer to an object than any other member of this imaging optical system is, and that the sixth lens group G6 is located closer to an image plane than any other member of this imaging optical system is. The sixth lens group G6 is an example of a rear lens group GR.

The imaging optical system forms an image at a point on the image plane S.

The first lens group G1 is made up of a first lens L1 having negative power and a second lens L2 having positive power. The first lens L1 and the second lens L2 are arranged in this order such that the first lens L1 is located closer to the object than the second lens L2 is and that the second lens L2 is located closer to the image plane than the first lens L1 is. The first lens L1 and the second lens L2 are bonded together with an adhesive, for example, to form a bonded lens.

The second lens group G2 is made up of: a third lens L3 having negative power; a fourth lens L4 having negative power; a fifth lens L5 having positive power; and a sixth lens L6 having negative power. The third lens L3, the fourth lens L4, the fifth lens L5, and the sixth lens L6 are arranged in this order such that the third lens L3 is located closer to the object than any other member of this second lens group G2 is and that the sixth lens L6 is located closer to the image plane than any other member of this second lens group G2 is. The fourth lens L4 and the fifth lens L5 are bonded together with an adhesive, for example, to form a bonded lens.

The third lens group G3 is made up of: a seventh lens L7 having positive power; an eighth lens L8 having positive power; a ninth lens L9 having negative power; and a tenth lens L10 having positive power. The ninth lens L9 and the tenth lens L10 are bonded together with an adhesive, for example, to form a bonded lens.

The fourth lens group G4 is made up of an eleventh lens L11 having positive power and a twelfth lens L12 having negative power.

The fifth lens group G5 is made up of a thirteenth lens L13 having negative power and a fourteenth lens L14 having negative power.

The sixth lens group G6 is made up of a fifteenth lens L15 having negative power and a sixteenth lens L16 having positive power. The fifteenth lens L15 and the sixteenth lens L16 are bonded together with an adhesive, for example, to form a bonded lens.

The respective lenses will be described.

First, the respective lenses that form the first lens group G1 will be described. The first lens L1 is a meniscus lens having a convex surface facing the object. The second lens L2 is a meniscus lens having a convex surface facing the object.

Next, the respective lenses that form the second lens group G2 will be described. The third lens L3 is a meniscus lens having a convex surface facing the object. The fourth lens L4 is a biconcave lens. The object-side surface of the fourth lens L4 has an aspheric shape. The fifth lens L5 is a meniscus lens having a convex surface facing the object. The sixth lens L6 is a meniscus lens having a convex surface facing the image plane.

Next, the respective lenses that form the third lens group G3 will be described. The seventh lens L7 is a meniscus lens having a convex surface facing the object. The eighth lens L8 is a biconvex lens. The ninth lens L9 is a biconcave lens. The tenth lens L10 is a meniscus lens having a convex surface facing the object.

Next, the respective lenses that form the fourth lens group G4 will be described. The eleventh lens L11 is a biconvex lens. The twelfth lens L12 is a meniscus lens having a convex surface facing the object. Both surfaces of the twelfth lens L12 have an aspheric shape.

Next, the respective lenses that form the fifth lens group G5 will be described. The thirteenth lens L13 is a meniscus lens having a convex surface facing the object. Both surfaces of the thirteenth lens L13 have an aspheric shape. The fourteenth lens L14 is a meniscus lens having a convex surface facing the image plane.

Next, the respective lenses that form the sixth lens group G6 will be described. The fifteenth lens L15 is a biconcave lens. The sixteenth lens L16 is a biconvex lens.

While the imaging optical system according to the second embodiment is zooming from the wide-angle end toward the telephoto end during a shooting session, the first lens group G1, the second lens group G2, the third lens group G3, the fourth lens group G4, the fifth lens group G5, and the sixth lens group G6 all move with respect to the image plane S. In the meantime, as the imaging optical system is zooming from the wide-angle end toward the telephoto end during the shooting session, the first, second, third, fourth, fifth, and sixth lens groups G1-G6 move along the optical axis such that the interval between the first lens group G1 and the second lens group G2 increases, the interval between the second lens group G2 and the third lens group G3 decreases, the interval between the third lens group G3 and the fourth lens group G4 decreases, the interval between the fourth lens group G4 and the fifth lens group G5 decreases from the wide-angle end through a middle position but increases from the middle position through the telephoto end, the interval between the fifth lens group G5 and the sixth lens group G6 increases, and the interval between the sixth lens group G6 and the image plane S increases,

While the imaging optical system according to the second embodiment is focusing to make a transition from the infinity in-focus state to the close-object in-focus state, the fifth lens group G5 moves along the optical axis toward the image plane.

### Third Embodiment

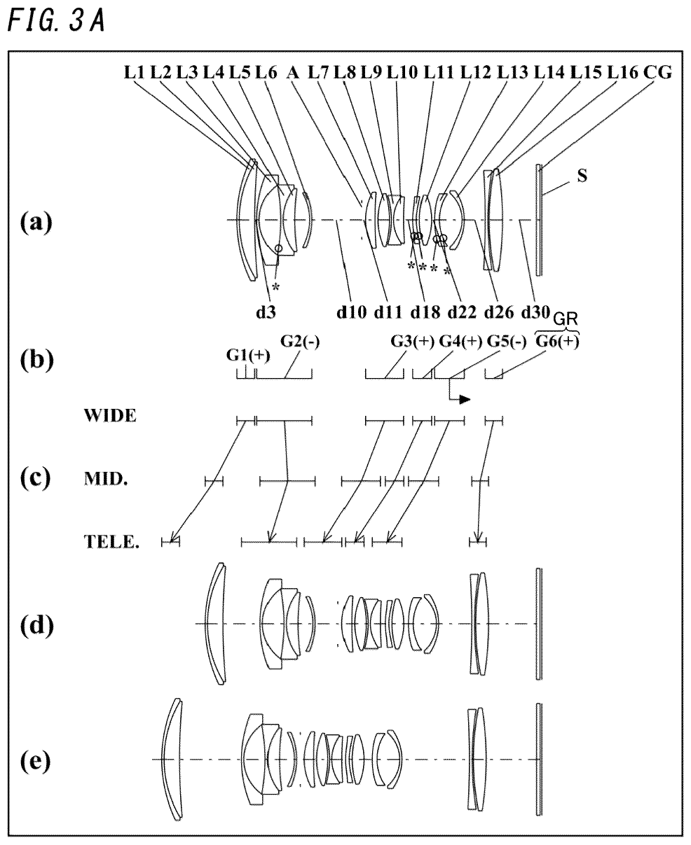

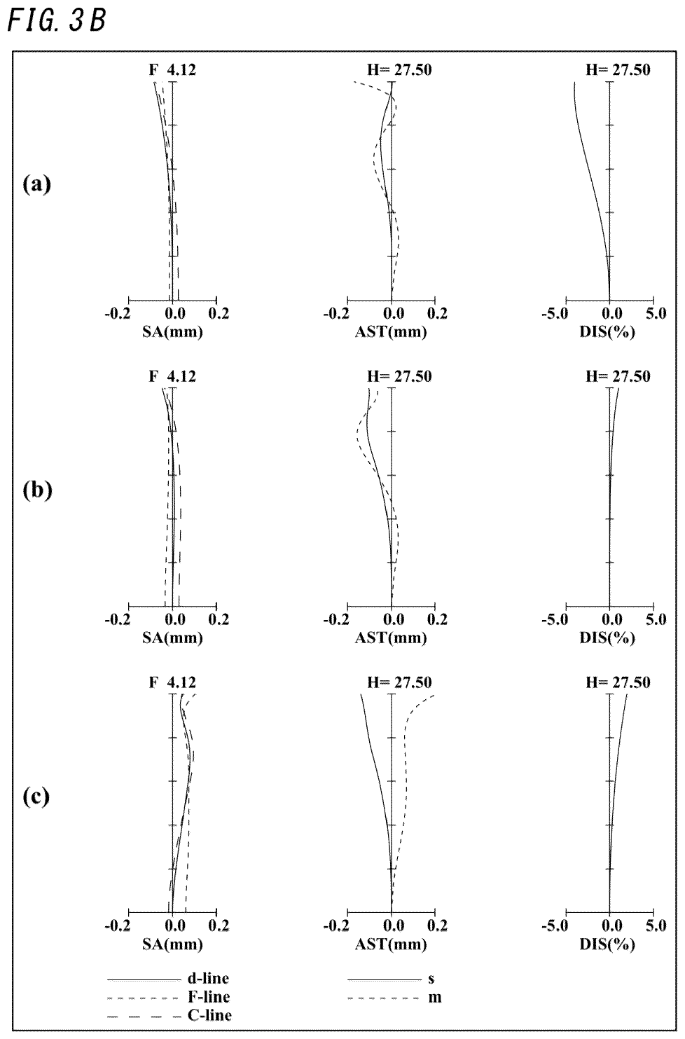

FIG. 3A illustrates an imaging optical system according to a third embodiment.

The imaging optical system is made up of: a first lens group G1 having positive power; a second lens group G2 having negative power; an aperture stop A; a third lens group G3 having positive power; a fourth lens group G4 having positive power; a fifth lens group G5 having negative power; and a sixth lens group G6 having positive power. The first lens group G1, the second lens group G2, the aperture stop A, the third lens group G3, the fourth lens group G4, the fifth lens group G5, and the sixth lens group G6 are arranged in this order such that the first lens group G1 is located closer to an object than any other member of this imaging optical system is, and that the sixth lens group G6 is located closer to an image plane than any other member of this imaging optical system is. The sixth lens group G6 is an example of a rear lens group GR.

The imaging optical system forms an image at a point on the image plane S.

The first lens group G1 is made up of a first lens L1 having negative power and a second lens L2 having positive power. The first lens L1 and the second lens L2 are arranged in this order such that the first lens L1 is located closer to the object than the second lens L2 is and that the second lens L2 is located closer to the image plane than the first lens L1 is. The first lens L1 and the second lens L2 are bonded together with an adhesive, for example, to form a bonded lens.

The second lens group G2 is made up of: a third lens L3 having negative power; a fourth lens L4 having negative power; a fifth lens L5 having positive power; and a sixth lens L6 having negative power. The third lens L3, the fourth lens L4, the fifth lens L5, and the sixth lens L6 are arranged in this order such that the third lens L3 is located closer to the object than any other member of this second lens group G2 is and that the sixth lens L6 is located closer to the image plane than any other member of this second lens group G2 is. The fourth lens L4 and the fifth lens L5 are bonded together with an adhesive, for example, to form a bonded lens.

The third lens group G3 is made up of: a seventh lens L7 having positive power; an eighth lens L8 having positive power; a ninth lens L9 having negative power; and a tenth lens L10 having positive power. The ninth lens L9 and the tenth lens L10 are bonded together with an adhesive, for example, to form a bonded lens.

The fourth lens group G4 is made up of an eleventh lens L11 having negative power and a twelfth lens L12 having positive power.

The fifth lens group G5 is made up of a thirteenth lens L13 having negative power and a fourteenth lens L14 having negative power.

The sixth lens group G6 is made up of a fifteenth lens L15 having negative power and a sixteenth lens L16 having positive power.

The respective lenses will be described.

First, the respective lenses that form the first lens group G1 will be described. The first lens L1 is a meniscus lens having a convex surface facing the object. The second lens L2 is a meniscus lens having a convex surface facing the object.

Next, the respective lenses that form the second lens group G2 will be described. The third lens L3 is a meniscus lens having a convex surface facing the object. The fourth lens L4 is a biconcave lens. The object-side surface of the fourth lens L4 has an aspheric shape. The fifth lens L5 is a meniscus lens having a convex surface facing the object. The sixth lens L6 is a meniscus lens having a convex surface facing the image plane.

Next, the respective lenses that form the third lens group G3 will be described. The seventh lens L7 is a meniscus lens having a convex surface facing the object. The eighth lens L8 is a biconvex lens. The ninth lens L9 is a biconcave lens. The tenth lens L10 is a meniscus lens having a convex surface facing the object.

Next, the respective lenses that form the fourth lens group G4 will be described. The eleventh lens L11 is a meniscus lens having a convex surface facing the object. Both surfaces of the eleventh lens L11 have an aspheric shape. The twelfth lens L12 is a biconvex lens.

Next, the respective lenses that form the fifth lens group G5 will be described. The thirteenth lens L13 is a meniscus lens having a convex surface facing the object. Both surfaces of the thirteenth lens L13 have an aspheric shape. The fourteenth lens L14 is a meniscus lens having a convex surface facing the image plane.

Next, the respective lenses that form the sixth lens group G6 will be described. The fifteenth lens L15 is a biconcave lens. The sixteenth lens L16 is a biconvex lens.

While the imaging optical system according to the third embodiment is zooming from the wide-angle end toward the telephoto end during a shooting session, the first lens group G1, the second lens group G2, the third lens group G3, the fourth lens group G4, the fifth lens group G5, and the sixth lens group G6 all move with respect to the image plane S. In the meantime, as the imaging optical system is zooming from the wide-angle end toward the telephoto end during the shooting session, the first, second, third, fourth, fifth, and sixth lens groups G1-G6 move along the optical axis such that the interval between the first lens group G1 and the second lens group G2 increases, the interval between the second lens group G2 and the third lens group G3 decreases, the interval between the third lens group G3 and the fourth lens group G4 decreases, the interval between the fourth lens group G4 and the fifth lens group G5 decreases, the interval between the fifth lens group G5 and the sixth lens group G6 increases, and the interval between the sixth lens group G6 and the image plane S increases,

While the imaging optical system according to the third embodiment is focusing to make a transition from the infinity in-focus state to the close-object in-focus state, the fifth lens group G5 moves along the optical axis toward the image plane.

### Fourth Embodiment

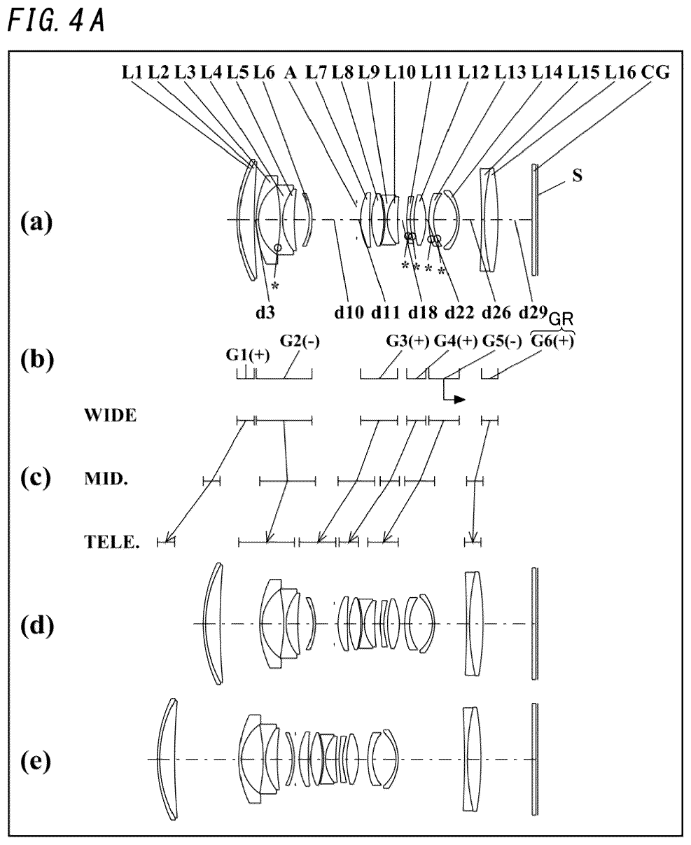

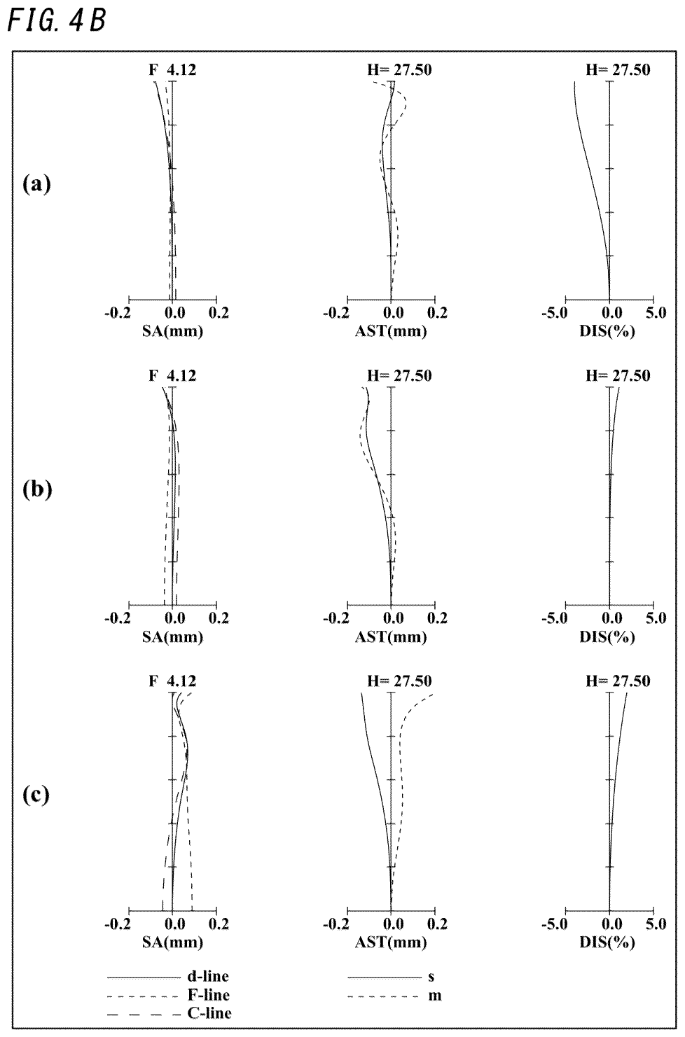

FIG. 4A illustrates an imaging optical system according to a fourth embodiment.

The imaging optical system is made up of: a first lens group G1 having positive power; a second lens group G2 having negative power; an aperture stop A; a third lens group G3 having positive power; a fourth lens group G4 having positive power; a fifth lens group G5 having negative power; and a sixth lens group G6 having positive power. The first lens group G1, the second lens group G2, the aperture stop A, the third lens group G3, the fourth lens group G4, the fifth lens group G5, and the sixth lens group G6 are arranged in this order such that the first lens group G1 is located closer to an object than any other member of this imaging optical system is, and that the sixth lens group G6 is located closer to an image plane than any other member of this imaging optical system is. The sixth lens group G6 is an example of a rear lens group GR.

The imaging optical system forms an image at a point on the image plane S.

The first lens group G1 is made up of a first lens L1 having negative power and a second lens L2 having positive power. The first lens L1 and the second lens L2 are arranged in this order such that the first lens L1 is located closer to the object than the second lens L2 is and that the second lens L2 is located closer to the image plane than the first lens L1 is. The first lens L1 and the second lens L2 are bonded together with an adhesive, for example, to form a bonded lens.

The second lens group G2 is made up of: a third lens L3 having negative power; a fourth lens L4 having negative power; a fifth lens L5 having positive power; and a sixth lens L6 having negative power. The third lens L3, the fourth lens L4, the fifth lens L5, and the sixth lens L6 are arranged in this order such that the third lens L3 is located closer to the object than any other member of this second lens group G2 is and that the sixth lens L6 is located closer to the image plane than any other member of this second lens group G2 is. The fourth lens L4 and the fifth lens L5 are bonded together with an adhesive, for example, to form a bonded lens.

The third lens group G3 is made up of: a seventh lens L7 having positive power; an eighth lens L8 having positive power; a ninth lens L9 having negative power; and a tenth lens L10 having positive power. The ninth lens L9 and the tenth lens L10 are bonded together with an adhesive, for example, to form a bonded lens.

The fourth lens group G4 is made up of an eleventh lens L11 having negative power and a twelfth lens L12 having positive power.

The fifth lens group G5 is made up of a thirteenth lens L13 having negative power and a fourteenth lens L14 having negative power.

The sixth lens group G6 is made up of a fifteenth lens L15 having negative power and a sixteenth lens L16 having positive power. The fifteenth lens L15 and the sixteenth lens L16 are bonded together with an adhesive, for example, to form a bonded lens.

The respective lenses will be described.

First, the respective lenses that form the first lens group G1 will be described. The first lens L1 is a meniscus lens having a convex surface facing the object. The second lens L2 is a meniscus lens having a convex surface facing the object.

Next, the respective lenses that form the second lens group G2 will be described. The third lens L3 is a meniscus lens having a convex surface facing the object. The fourth lens L4 is a biconcave lens. The object-side surface of the fourth lens L4 has an aspheric shape. The fifth lens L5 is a meniscus lens having a convex surface facing the object. The sixth lens L6 is a meniscus lens having a convex surface facing the image plane.

Next, the respective lenses that form the third lens group G3 will be described. The seventh lens L7 is a meniscus lens having a convex surface facing the object. The eighth lens L8 is a biconvex lens. The ninth lens L9 is a biconcave lens. The tenth lens L10 is a meniscus lens having a convex surface facing the object.

Next, the respective lenses that form the fourth lens group G4 will be described. The eleventh lens L11 is a meniscus lens having a convex surface facing the object. The twelfth lens L12 is a biconvex lens.

Next, the respective lenses that form the fifth lens group G5 will be described. The thirteenth lens L13 is a meniscus lens having a convex surface facing the object. Both surfaces of the thirteenth lens L13 have an aspheric shape. The fourteenth lens L14 is a meniscus lens having a convex surface facing the image plane.

Next, the respective lenses that form the sixth lens group G6 will be described. The fifteenth lens L15 is a biconcave lens. The sixteenth lens L16 is a biconvex lens.

While the imaging optical system according to the fourth embodiment is zooming from the wide-angle end toward the telephoto end during a shooting session, the first lens group G1, the second lens group G2, the third lens group G3, the fourth lens group G4, the fifth lens group G5, and the sixth lens group G6 all move with respect to the image plane S. In the meantime, as the imaging optical system is zooming from the wide-angle end toward the telephoto end during the shooting session, the first, second, third, fourth, fifth, and sixth lens groups G1-G6 move along the optical axis such that the interval between the first lens group G1 and the second lens group G2 increases, the interval between the second lens group G2 and the third lens group G3 decreases, the interval between the third lens group G3 and the fourth lens group G4 decreases, the interval between the fourth lens group G4 and the fifth lens group G5 increases, the interval between the fifth lens group G5 and the sixth lens group G6 increases, and the interval between the sixth lens group G6 and the image plane S increases,

While the imaging optical system according to the fourth embodiment is focusing to make a transition from the infinity in-focus state to the close-object in-focus state, the fifth lens group G5 moves along the optical axis toward the image plane.

### Fifth Embodiment

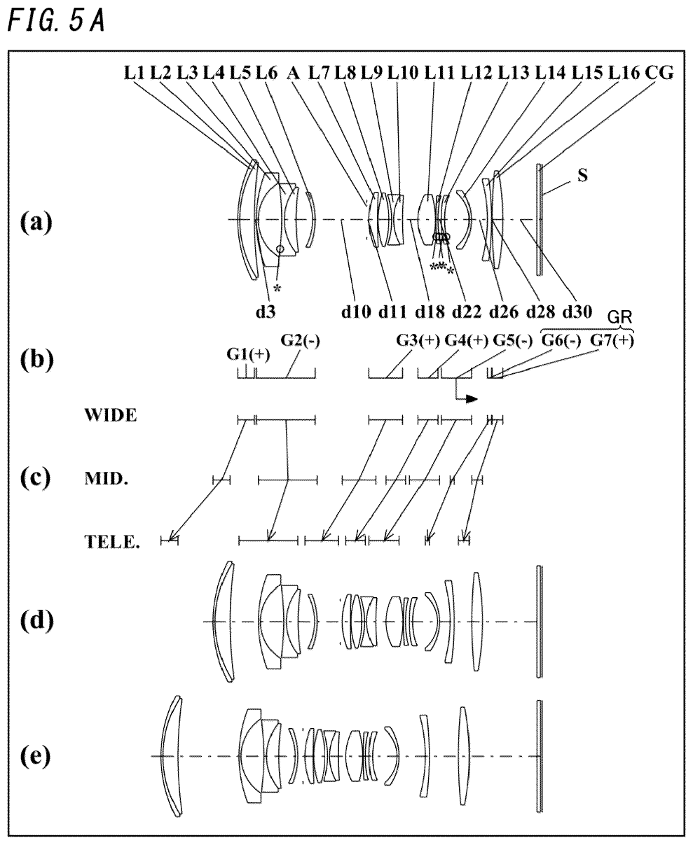

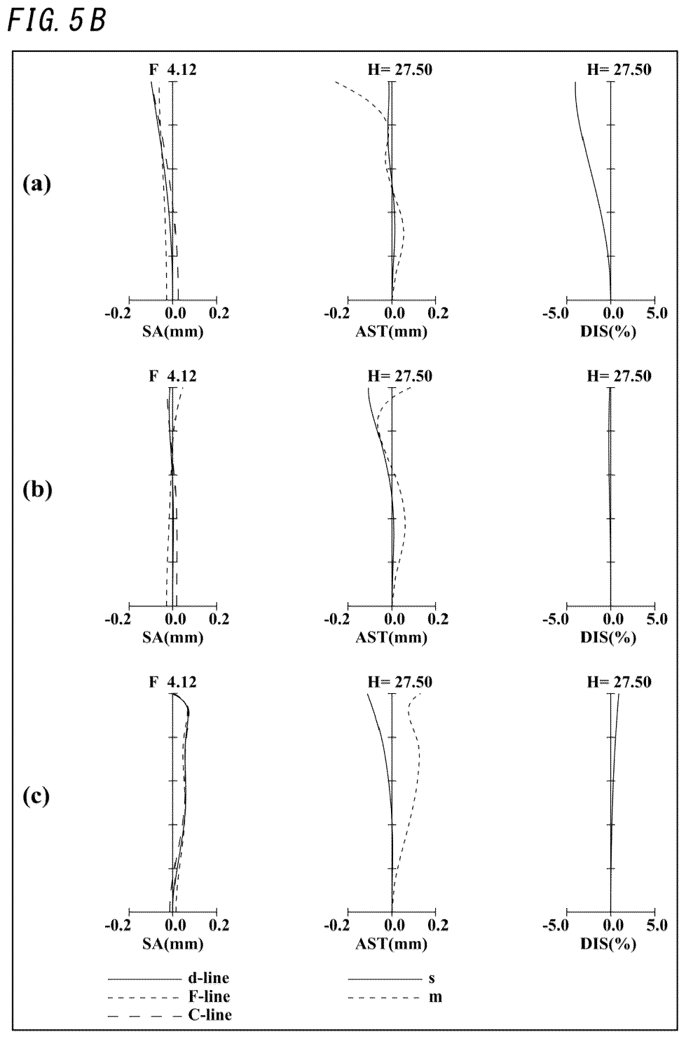

FIG. 5A illustrates an imaging optical system according to a fifth embodiment.

The imaging optical system is made up of: a first lens group G1 having positive power; a second lens group G2 having negative power; an aperture stop A; a third lens group G3 having positive power; a fourth lens group G4 having positive power; a fifth lens group G5 having negative power; a sixth lens group G6 having negative power; and a seventh lens group G7 having positive power. The first lens group G1, the second lens group G2, the aperture stop A, the third lens group G3, the fourth lens group G4, the fifth lens group G5, the sixth lens group G6, and the seventh lens group G7 are arranged in this order such that the first lens group G1 is located closer to an object than any other member of this imaging optical system is, and that the seventh lens group G7 is located closer to an image plane than any other member of this imaging optical system is. The sixth lens group G6 and the seventh lens group G7 are an example of a rear lens group GR.

The imaging optical system forms an image at a point on the image plane S.

The first lens group G1 is made up of a first lens L1 having negative power and a second lens L2 having positive power. The first lens L1 and the second lens L2 are arranged in this order such that the first lens L1 is located closer to the object than the second lens L2 is and that the second lens L2 is located closer to the image plane than the first lens L1 is. The first lens L1 and the second lens L2 are bonded together with an adhesive, for example, to form a bonded lens.

The second lens group G2 is made up of: a third lens L3 having negative power; a fourth lens L4 having negative power; a fifth lens L5 having positive power; and a sixth lens L6 having negative power. The third lens L3, the fourth lens L4, the fifth lens L5, and the sixth lens L6 are arranged in this order such that the third lens L3 is located closer to the object than any other member of this second lens group G2 is and that the sixth lens L6 is located closer to the image plane than any other member of this second lens group G2 is. The fourth lens L4 and the fifth lens L5 are bonded together with an adhesive, for example, to form a bonded lens.

The third lens group G3 is made up of: a seventh lens L7 having positive power; an eighth lens L8 having positive power; a ninth lens L9 having negative power; and a tenth lens L10 having positive power. The ninth lens L9 and the tenth lens L10 are bonded together with an adhesive, for example, to form a bonded lens.

The fourth lens group G4 is made up of an eleventh lens L11 having positive power and a twelfth lens L12 having negative power.

The fifth lens group G5 is made up of a thirteenth lens L13 having negative power and a fourteenth lens L14 having negative power.

The sixth lens group G6 consists of a fifteenth lens L15 having negative power.

The seventh lens group G7 consists of a sixteenth lens L16 having positive power.

The respective lenses will be described.

First, the respective lenses that form the first lens group G1 will be described. The first lens L1 is a meniscus lens having a convex surface facing the object. The second lens L2 is a meniscus lens having a convex surface facing the object.

Next, the respective lenses that form the second lens group G2 will be described. The third lens L3 is a meniscus lens having a convex surface facing the object. The fourth lens L4 is a biconcave lens. The object-side surface of the fourth lens L4 has an aspheric shape. The fifth lens L5 is a meniscus lens having a convex surface facing the object. The sixth lens L6 is a meniscus lens having a convex surface facing the image plane.

Next, the respective lenses that form the third lens group G3 will be described. The seventh lens L7 is a meniscus lens having a convex surface facing the object. The eighth lens L8 is a biconvex lens. The ninth lens L9 is a biconcave lens. The tenth lens L10 is a meniscus lens having a convex surface facing the object.

Next, the respective lenses that form the fourth lens group G4 will be described. The eleventh lens L11 is a biconvex lens. The twelfth lens L12 is a meniscus lens having a convex surface facing the object. Both surfaces of the twelfth lens L12 have an aspheric shape.

Next, the respective lenses that form the fifth lens group G5 will be described. The thirteenth lens L13 is a meniscus lens having a convex surface facing the object. Both surfaces of the thirteenth lens L13 have an aspheric shape. The fourteenth lens L14 is a meniscus lens having a convex surface facing the image plane.

Next, the lens serving as the sixth lens group G6 will be described. The fifteenth lens L15 is a meniscus lens having a convex surface facing the image plane.

Next, the lens serving as the seventh lens group G7 will be described. The sixteenth lens L16 is a biconvex lens.

While the imaging optical system according to the fifth embodiment is zooming from the wide-angle end toward the telephoto end during a shooting session, the first lens group G1, the second lens group G2, the third lens group G3, the fourth lens group G4, the fifth lens group G5, the sixth lens group G6, and the seventh lens group G7 all move with respect to the image plane S. In the meantime, as the imaging optical system is zooming from the wide-angle end toward the telephoto end during the shooting session, the first, second, third, fourth, fifth, sixth, and seventh lens groups G1-G7 move along the optical axis such that the interval between the first lens group G1 and the second lens group G2 increases, the interval between the second lens group G2 and the third lens group G3 decreases, the interval between the third lens group G3 and the fourth lens group G4 decreases, the interval between the fourth lens group G4 and the fifth lens group G5 increases from the wide-angle end through a middle position but decreases from the middle position through the telephoto end, the interval between the fifth lens group G5 and the sixth lens group G6 decreases from the wide-angle end through a middle position but increases from the middle position through the telephoto end, the interval between the sixth lens group G6 and the seventh lens group G7 increases, and the interval between the seventh lens group G7 and the image plane S increases,

While the imaging optical system according to the fifth embodiment is focusing to make a transition from the infinity in-focus state to the close-object in-focus state, the fifth lens group G5 moves along the optical axis toward the image plane.

### Other Embodiments

The first, second, third, fourth, and fifth embodiments have been described as exemplary embodiments of the present disclosure. Note that the embodiments described above are only examples of the present disclosure and should not be construed as limiting. Rather, each of these embodiments may be readily modified, replaced, combined with other embodiments, provided with some additional components, or partially omitted without departing from the scope of the present disclosure.

The imaging optical system according to each of the first through fifth embodiments described above is configured to cause the aperture stop A to move along with the third lens group G3 during zooming. Alternatively, the aperture stop A may be arranged to be located closer to the image plane S than the second lens group G2 is, and may be configured to move along with the second lens group G2 during zooming. Also, even though the structure of the lens barrel would be complicated if the aperture stop A is allowed to move to draw a different locus from other lens groups during zooming, the aperture stop A may move to draw a different locus from the second lens group G2 or the third lens group G3. In that case, the aperture stop A may be interposed between the second lens group G2 and the third lens group G3. Nevertheless, if the imaging optical system is configured to allow the aperture stop A to move along with either the second lens group G2 or the third lens group G3, then the structure of a lens barrel for moving the aperture stop A will be complicated to a lesser degree.

In the first to fifth embodiments described above, the imaging optical system is supposed to be used in the entire zoom range from the wide-angle end through the telephoto end. However, the imaging optical system does not have to be used in the entire zoom range. Alternatively, the imaging optical system may also be used selectively only in an extracted range where optical performance is ensured according to the desired zoom range, for example. That is to say, the imaging optical system may also be used as an imaging optical system with lower zoom power than the imaging optical system to be described for the first, second, third, fourth, and fifth examples of numerical values corresponding to the first, second, third, fourth, and fifth embodiments, respectively. Optionally, the imaging optical system may also be used selectively as a single-focus lens system only at an extracted focal length where optical performance is ensured according to the desired zoom position.

In addition, the number of the lens groups and the number of the lenses that form each lens group are substantial numbers. Optionally, a lens having substantially no power may be added to any of the lens groups described above.

### (Conditions and Advantages)

Next, conditions that may be satisfied by the imaging optical systems according to the first to fifth embodiments, for example, will be described. A plurality of possible conditions may be defined for the imaging optical system according to each of the first to fifth embodiments. In that case, an imaging optical system, of which the configuration satisfies all of these possible conditions, is most advantageous. Alternatively, an imaging optical system that achieves its expected advantages by satisfying any of the individual conditions to be described below may also be provided.

In the following description, unless otherwise stated, the deviation ΔθgF of the partial dispersion ratio of a lens of interest is supposed to be a value determined by the following equation (A):

$$Δθ gF = θ gF - ( 0.648285 - 0.00180123 \times vd ) \qquad ( A )$$

where θgF is a partial dispersion ratio in response to a g-line and vd is an abbe number in response to a d-line.

An imaging optical system according to each of the first to fifth embodiments described above consists of: a first lens group G1 having positive power; a second lens group G2 having negative power; an aperture stop A; a third lens group G3 having positive power; a fourth lens group G4 having positive power; a fifth lens group G5 having negative power; and a rear lens group GR including one or more lens groups each having power. The first lens group G1, the second lens group G2, the aperture stop A, the third lens group G3, the fourth lens group G4, the fifth lens group G5, and the rear lens group GR are arranged in this order such that the first lens group G1 is located closer to an object than the second lens group G2, the aperture stop A, the third lens group G3, the fourth lens group G4, the fifth lens group G5, or the rear lens group GR is, and that the rear lens group GR is located closer to an image plane than the first lens group G1, the second lens group G2, the aperture stop A, the third lens group G3, the fourth lens group G4, or the fifth lens group G5 is. The fifth lens group G5 consists of: a first negative meniscus lens having a convex surface facing the object; and a second negative meniscus lens having a convex surface facing the image plane. The first negative meniscus lens and the second negative meniscus lens are arranged in this order such that the first negative meniscus lens is located closer to the object than the second negative meniscus lens is and that the second negative meniscus lens is located closer to the image plane than the first negative meniscus lens is. An interval between two adjacent ones of the first, second, third, fourth, and fifth lens groups G1-G5 and the one or more lens groups of the rear lens group GR changes while the imaging optical system is zooming from a wide-angle end toward a telephoto end. The fifth lens group G5 moves in a direction pointing from the object toward the image plane while the imaging optical system is focusing to make a transition from an infinity in-focus state toward a close-object in-focus state.

This allows various types of aberrations produced by the respective lens groups during zooming to be compensated for sufficiently with the overall size of the imaging optical system reduced, thus providing an imaging optical system having the ability to compensate for various types of aberrations sufficiently over the entire zoom range.

In addition, making the fifth lens group G5 that moves during focusing up of two negative lenses that face each other allows for reducing variations in various types of aberrations (such as astigmatism and distortion, among other things) during focusing while reducing the weight of the focus group.

In the imaging optical system, the second lens group G2 preferably includes a bonded lens, and the imaging optical system preferably satisfies the following inequality (1):

$$- 0.002 < Δθ gF\_ 2 p < 0.015 \qquad ( 1 )$$

where ΔθgF_2p is a deviation ΔθgF of a partial dispersion ratio of a positive lens, which is one of two lenses that form the bonded lens, in response to a g-line.

The condition expressed by this inequality (1) defines a preferred range of the deviation ΔθgF of a partial dispersion ratio of a positive lens, which is one of two lenses that form a bonded lens in the second lens group G2 in the imaging optical system, in response to a g-line.

If ΔθgF_2p were less than the lower limit value set by this inequality (1), then it would be difficult to compensate for various types of aberrations (e.g., the axial chromatic aberration at the wide-angle end, among other things), which is not beneficial.

Conversely, if ΔθgF_2p were greater than the upper limit value set by this inequality (1), then it would be difficult to compensate for various types of aberrations (e.g., the chromatic aberration of magnification at the wide-angle end, among other things), which is not beneficial, either.

To enhance the advantage described above, the condition(s) expressed by one or both of the following inequalities (1a) and (1b) is/are preferably satisfied:

$$0. < Δθ gF\_ 2 p \qquad ( 1 a )$$

$$ΔθgF\_ 2 p < 0.01 . \qquad ( 1 b )$$

More preferably, to further enhance the advantage described above, the condition(s) expressed by one or both of the following inequalities (1c) and (1d) is/are satisfied:

$$0.002 < ΔθgF\_ 2 p \qquad ( 1 c )$$

$$ΔθgF\_ 2 p < 0.008 . \qquad ( 1 d )$$

Also, in the imaging optical system, the second lens group G2 preferably includes a bonded lens, and the imaging optical system preferably satisfies the following inequality (2):

$$50 < vd\_ 2 n < 90 \qquad ( 2 )$$

where vd_2n is an abbe number of a negative lens, which is one of two lenses that form the bonded lens, in response to a d-line.

The condition expressed by this inequality (2) defines a preferred range of an abbe number of a negative lens, which is one of two lenses that form the bonded lens in the second lens group G2 in the imaging optical system, in response to a d-line.

If vd_2n were less than the lower limit value set by this inequality (2), then it would be difficult to compensate for various types of aberrations (e.g., the chromatic aberration of magnification at the wide-angle end, among other things), which is not beneficial.

Conversely, if vd_2n were greater than the upper limit value set by this inequality (2), then the sensitivity would increase so much at the time of eccentricity to make it difficult to make a product as designed, which is not beneficial, either.

To enhance the advantage described above, the condition(s) expressed by one or both of the following inequalities (2a) and (2b) is/are preferably satisfied:

$$55 < vd\_ 2 n \qquad ( 2 a )$$

$$vd\_ 2 n < 85. \qquad ( 2 b )$$

More preferably, to further enhance the advantage described above, the condition(s) expressed by one or both of the following inequalities (2c) and (2d) is/are satisfied:

$$60 < vd\_ 2 n \qquad ( 2 c )$$

$$vd\_ 2 n < 80. \qquad ( 2 d )$$

Furthermore, in the imaging optical system, the third lens group G3 preferably includes a bonded lens, and the imaging optical system preferably satisfies the following inequality (3):

$$- 0.010 < ΔθgF\_ 3 n < 0.005 \qquad ( 3 )$$

where ΔθgF_3n is a deviation ΔθgF of a partial dispersion ratio of a negative lens, which is one of two lenses that form the bonded lens, in response to a g-line.

The condition expressed by this inequality (3) defines a preferred range of the deviation ΔθgF of a partial dispersion ratio of a negative lens, which is one of two lenses that form the bonded lens in the third lens group G3 in the imaging optical system, in response to a g-line.

If ΔθgF_3n were less than the lower limit value set by this inequality (3) or if ΔθgF_3n were greater than the upper limit value set by this inequality (3), then it would be difficult to compensate for the chromatic aberration of a second-order spectrum, thus making it difficult to compensate for various types of aberrations (such as axial chromatic aberration, among other things), which is not beneficial.

To enhance the advantage described above, the condition(s) expressed by one or both of the following inequalities (3a) and (3b) is/are preferably satisfied:

$$- 0.008 < ΔθgF\_ 3 n \qquad ( 3 a )$$

$$ΔθgF\_ 3 n < 0.003 . \qquad ( 3 b )$$

More preferably, to further enhance the advantage described above, the condition(s) expressed by one or both of the following inequalities (3c) and (3d) is/are satisfied:

$$- 0.005 < ΔθgF\_ 3 n \qquad ( 3 c )$$

$$ΔθgF\_ 3 n < 0.001 . \qquad ( 3 d )$$

Furthermore, the imaging optical system preferably includes at least three positive lenses located closer to the image plane than the aperture stop A is. Each of the at least three positive lenses preferably satisfies the following inequality (4):

$$50 < vdp < 100 \qquad ( 4 )$$

where vdp is an abbe number of each of the at least three positive lenses located closer to the image plane than the aperture stop A is.

The condition expressed by this inequality (4) defines a preferred range of an abbe number of at least three positive lenses located closer to the image plane than the aperture stop A is.

If vdp were less than the lower limit value set by this inequality (4), then it would be difficult to compensate for various types of aberrations (e.g., the axial chromatic aberration, among other things), which is not beneficial.

Conversely, if vdp were greater than the upper limit value set by this inequality (4), then it would be difficult to compensate for various types of aberrations (e.g., the chromatic aberration of magnification at the telephoto end, among other things), which is not beneficial, either.

To enhance the advantage described above, the condition(s) expressed by one or both of the following inequalities (4a) and (4b) is/are preferably satisfied:

$$55 < vdp \qquad ( 4 a )$$

$$vdp < 95. \qquad ( 4 b )$$

More preferably, to further enhance the advantage described above, the condition(s) expressed by one or both of the following inequalities (4c) and (4d) is/are satisfied:

$$60 < vdp \qquad ( 4 c )$$

$$vdp < 90. \qquad ( 4 d )$$

Furthermore, in the imaging optical system, a lens located closest to the image plane is preferably a positive lens, and the imaging optical system preferably satisfies the following inequality (5):

$$0.012 < ΔθgF\_Lp < 0.040 \qquad ( 5 )$$

where ΔθgF_Lp is a deviation ΔθgF of a partial dispersion ratio of the positive lens located closest to the image plane in response to a g-line.

The condition expressed by this inequality (5) defines a preferred range of the deviation ΔθgF of a partial dispersion ratio of the positive lens located closest in the imaging optical system to the image plane in response to a g-line.

If ΔθgF_Lp were less than the lower limit value set by this inequality (5), then it would be difficult to compensate for various types of aberrations (e.g., the chromatic aberration of magnification at the wide-angle end, among other things), which is not beneficial.

Conversely, if ΔθgF_Lp were greater than the upper limit value set by this inequality (5), then it would be difficult to compensate for various types of aberrations (e.g., the chromatic aberration of magnification at the telephoto end, among other things), which is not beneficial, either.

To enhance the advantage described above, the condition(s) expressed by one or both of the following inequalities (5a) and (5b) is/are preferably satisfied:

$$0.013 < ΔθgF\_Lp \qquad ( 5 a )$$

$$ΔθgF\_Lp < 0. 0 38. \qquad ( 5 b )$$

More preferably, to further enhance the advantage described above, the condition(s) expressed by one or both of the following inequalities (5c) and (5d) is/are satisfied:

$$0.015 < ΔθgF\_Lp \qquad ( 5 c )$$

$$ΔθgF\_Lp < 0. 0 35. \qquad ( 5 d )$$

Furthermore, the imaging optical system preferably satisfies the following inequality (6):

$$0.5 < BFw / Yw < 1. \qquad ( 6 )$$

where BFw is a distance from a lens located closest to the image plane to the image plane at the wide-angle end, and
Yw is a maximum image height at the wide-angle end.

The condition expressed by this inequality (6) defines a preferred ratio of a distance from a lens located closest to the image plane to the image plane at the wide-angle end to a maximum image height at the wide-angle end in the imaging optical system.

If the BFw/Yw ratio were less than the lower limit value set by this inequality (6), then the lens located closest to the image plane would be likely to interfere with the image capturing plane, which is not beneficial.

Conversely, if the BFw/Yw ratio were greater than the upper limit value set by this inequality (5), then the overall size of the imaging optical system would increase significantly, which is not beneficial, either.

To enhance the advantage described above, the condition(s) expressed by one or both of the following inequalities (6a) and (6b) is/are preferably satisfied:

$$0.6 < BFw / Yw \qquad ( 6 a )$$

$$BFw / Yw < 0.8 . \qquad ( 6 b )$$

More preferably, to further enhance the advantage described above, the condition(s) expressed by one or both of the following inequalities (6c) and (6d) is/are satisfied:

$$0.7 < BFw / Yw \qquad ( 6 c )$$

$$BFw / Yw < 0.75 . \qquad ( 6 d )$$

Furthermore, the imaging optical system preferably satisfies the following inequality (7):

$$0. < f 3 / fGRw < 1. \qquad ( 7 )$$

where f3 is a focal length of the third lens group G3, and
fGRw is a focal length of the rear lens group GR at the wide-angle end.

The condition expressed by this inequality (7) defines a preferred ratio of the focal length of the third lens group G3 to the focal length of the rear lens group GR at the wide-angle end in the imaging optical system.

If the f3/fGRw ratio were less than the lower limit value set by this inequality (7), then it would be difficult to compensate for various types of aberrations (e.g., the coma aberration, among other things), which is not beneficial.

Conversely, if the f3/fGRw ratio were greater than the upper limit value set by this inequality (7), then it would be difficult to compensate for various types of aberrations (e.g., the field curvature among other things), which is not beneficial, either.

To enhance the advantage described above, the condition(s) expressed by one or both of the following inequalities (7a) and (7b) is/are preferably satisfied:

$$0.2 < f 3 / fGRw \qquad ( 7 a )$$

$$f 3 / fGRw < 0.8 . \qquad ( 7 b )$$

More preferably, to further enhance the advantage described above, the condition(s) expressed by one or both of the following inequalities (7c) and (7d) is/are satisfied:

$$0.4 < f 3 / fGRw \qquad ( 7 c )$$

$$f 3 / fGRw < 0.65 . \qquad ( 7 d )$$

Furthermore, the imaging optical system preferably satisfies the following inequality (8):

$$0.5 < \vert f 5 / f 4 \vert < 2. \qquad ( 8 )$$

where f4 is a focal length of the fourth lens group G4, and
f5 is a focal length of the fifth lens group G5.

The condition expressed by this inequality (8) defines a preferred ratio of the focal length of the fifth lens group G5 to the focal length of the fourth lens group G4 in the imaging optical system.

If the f5/f4l ratio were less than the lower limit value set by this inequality (8), then the focus group would be oversized, which is not beneficial.

Conversely, if the |f5/f4| ratio were greater than the upper limit value set by this inequality (8), then it would be difficult to compensate for the variation in aberration during focusing, which is not beneficial, either.

To enhance the advantage described above, the condition(s) expressed by one or both of the following inequalities (8a) and (8b) is/are preferably satisfied:

$$1. < \vert f 5 / f 4 \vert \qquad ( 8 a )$$

$$\vert f 5 / f 4 \vert < 1.5 . \qquad ( 8 b )$$

More preferably, to further enhance the advantage described above, the condition(s) expressed by one or both of the following inequalities (8c) and (8d) is/are satisfied:

$$1.1 < \vert f 5 / f 4 \vert \qquad ( 8 c )$$

$$\vert f 5 / f 4 \vert < 1.3 . \qquad ( 8 d )$$

Furthermore, the imaging optical system preferably satisfies the following inequality (9):

$$0.2 < tGR / tG 5 < 1. \qquad ( 9 )$$

where tG5 is the length of the fifth lens group G5 on an optical axis, and
tGR is a length on the optical axis from an object-side surface of a lens located closest to the object in the rear lens group GR to an image-side surface of a lens located closest to the image plane in the rear lens group GR at the wide-angle end.

The condition expressed by this inequality (9) defines a preferred ratio of a length on the optical axis from an object-side surface of a lens located closest to the object in the rear lens group GR to an image-side surface of a lens located closest to the image plane in the rear lens group GR to the length of the fifth lens group G5 on the optical axis at the wide-angle end in the imaging optical system.

If the tGR/tG5 ratio were less than the lower limit value set by this inequality (9), then it would be difficult to compensate for various types of aberrations (e.g., the field curvature and distortion, among other things), which is not beneficial.

Conversely, if the tGR/tG5 ratio were greater than the upper limit value set by this inequality (9), then it would be difficult to compensate for the variation in aberration during focusing, which is not beneficial, either.

To enhance the advantage described above, the condition(s) expressed by one or both of the following inequalities (9a) and (9b) is/are preferably satisfied:

$$0.3 < t G R / tG 5 \qquad ( 9 a )$$

$$tGR / tG 5 < 0.9 . \qquad ( 9 b )$$

More preferably, to further enhance the advantage described above, the condition(s) expressed by one or both of the following inequalities (9c) and (9d) is/are satisfied:

$$0.4 < t G R / tG 5 \qquad ( 9 c )$$

$$tGR / tG 5 < 0.8 . \qquad ( 9 d )$$

(Schematic Configuration for Image Capture Device to which First Embodiment is Applied)

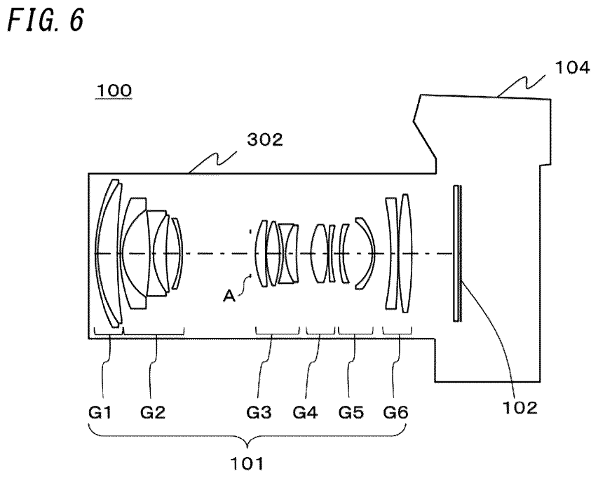

FIG. 6 illustrates a schematic configuration for an image capture device, to which the imaging optical system according to the first embodiment is applied. Alternatively, the imaging optical system according to the second, third, fourth, or fifth embodiment is also applicable to the image capture device.

The image capture device 100 includes a housing 104, an image sensor 102, and the imaging optical system 101 according to the first embodiment. Specifically, the image capture device 100 may be implemented as a digital camera, for example.

The housing 104 includes a lens barrel 302. The lens barrel 302 holds the respective lens groups (including the aperture stop A) that form the imaging optical system 101.

The image sensor 102 is disposed at the image plane S of the imaging optical system according to the first embodiment.

In the imaging optical system 101, the first lens group G1, the second lens group G2, the third lens group G3, the fourth lens group G4, the fifth lens group G5, and the sixth lens group G6 are attached to, or engaged with, a lens frame included in the lens barrel 302 to make the lens frame holding the respective lens groups G1-G6 movable while the imaging optical system 101 is zooming.

In the imaging optical system 101 that includes the respective lens groups held by the lens barrel 302, an actuator, a lens frame, and other members to be controlled by the controller in the image capture device 100 are provided such that the fifth lens group G5 may move while the imaging optical system 101 is focusing.

This allows for providing an image capture device with the ability to compensate for various types of aberrations sufficiently.

In the example described above, the imaging optical system according to the first embodiment is applied to a digital camera. However, this is only an example and should not be construed as limiting. Alternatively, the imaging optical system is also applicable to a digital camcorder, a surveillance camera, a smartphone, or any of various other types of image capture devices.

(Schematic Configuration for Camera System to which First Embodiment is Applied)

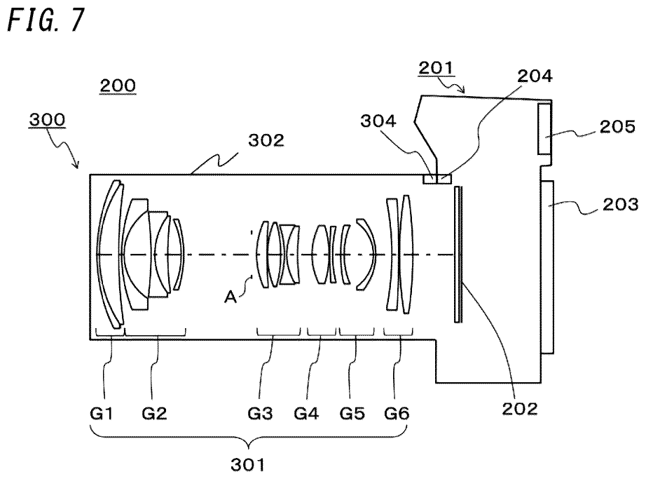

FIG. 7 illustrates a schematic configuration for a camera system, to which the imaging optical system according to the first embodiment is applied. Alternatively, the imaging optical system according to the second, third, fourth, or fifth embodiment is also applicable to the camera system.

The camera system 200 includes a camera body 201 and an interchangeable lens unit 300 to be connected removably to the camera body 201.

The camera body 201 includes an image sensor 202, a monitor 203, a memory, a camera mount 204, and a viewfinder 205. The image sensor 202 receives an optical image of an object formed by the imaging optical system 301 of the interchangeable lens unit 300 and transforms the optical image into an electrical image signal. The monitor 203 displays the electrical image signal transformed by the image sensor 202. The memory stores the electrical image signal.

The imaging optical system 301 of the interchangeable lens unit 300 is the imaging optical system according to the first embodiment.

The interchangeable lens unit 300 includes not only the imaging optical system 301 but also a lens barrel 302 and a lens mount 304 as well. The lens barrel 302 holds the respective lens groups and aperture stop A that form the imaging optical system 301. The lens mount 304 is to be connected to the camera mount 204 of the camera body 201.

The camera mount 204 and the lens mount 304 are physically connected together. In addition, the camera mount 204 and the lens mount 304 also electrically connect together a controller in the camera body 201 and a controller in the interchangeable lens unit 300. That is to say, the camera mount 204 and the lens mount 304 serve as interfaces that allow themselves to exchange signals with each other.

In the imaging optical system 301, the first lens group G1, the second lens group G2, the third lens group G3, the fourth lens group G4, the fifth lens group G5, and the sixth lens group G6 are attached to, or engaged with, a lens frame included in the lens barrel 302 to make the lens frame holding these lens groups G1-G6 movable while the imaging optical system 101 is zooming.

In the camera system 200 including the respective lens groups held by the lens barrel 302 and the camera body 201, an actuator, a lens frame, and other members to be controlled by the controller in the interchangeable lens unit 300 are provided such that the fifth lens group G5 may move while the imaging optical system 301 is focusing.

This allows for providing a camera system having the ability to compensate for various types of aberrations sufficiently.

In the example described above, the imaging optical system according to the first embodiment is applied to a digital camera. However, this is only an example and should not be construed as limiting. Alternatively, the imaging optical system according to the first embodiment is also applicable to a digital camcorder, a surveillance camera, a smartphone, and various other image capture devices.

### Examples of Numerical Values

Next, exemplary sets of specific numerical values that were actually adopted in the imaging optical systems with the configurations according to the first, second, third, fourth, and fifth embodiments will be described. Note that in the tables showing these exemplary sets of numerical values, the length is expressed in millimeters (mm), the angle of view is expressed in degrees (°), r indicates the radius of curvature, d indicates the surface interval, nd indicates a refractive index in response to a d-line, νd (also denoted as “vd”) indicates an abbe number in response to a d-line, and a surface with an asterisk (*) is an aspheric surface. The aspheric shape is defined by the following equation:

$$Z = \frac{{h}^{2} / r}{1 + \sqrt{1 - ( 1 + κ ) {( h / r )}^{2}}} + \sum {A}_{n} {h}^{n}$$

where Z is the distance from a point on an aspheric surface, located at a height h measured from the optical axis, to a tangent plane defined with respect to the vertex of the aspheric surface, h is the height as measured from the optical axis, r is the radius of curvature of the vertex, x is a conic constant, and An is an n^{th} order aspheric surface coefficient.

FIGS. 1B, 2B, 3B, 4B, and 5B are longitudinal aberration diagrams showing what state the imaging optical systems according to the first, second, third, fourth, and fifth embodiments assume in the infinity in-focus state.

In each longitudinal aberration diagram, portion (a) shows the longitudinal aberrations at the wide-angle end, portion (b) shows the longitudinal aberrations at the middle position, and portion (c) shows the longitudinal aberrations at the telephoto end. Each of portions (a), (b) and (c) of these longitudinal aberration diagrams shows spherical aberration (SA (mm)), astigmatism (AST (mm)), and distortion (DIS (%)) in this order from left to right. In each spherical aberration diagram, the ordinate indicates the F number (designated by “F” on the drawings), the solid curve indicates a characteristic in response to a d-line, the shorter dashed curve indicates a characteristic in response to an F-line, and the longer dashed curve indicates a characteristic in response to a C-line. In each astigmatism diagram, the ordinate indicates the image height (designated by “H” on the drawings), the solid curve indicates a characteristic with respect to a sagittal plane (designated by “s” on the drawings), and the dotted curve indicates a characteristic with respect to a meridional plane (designated by “m” on the drawings). Furthermore, in each distortion diagram, the ordinate indicates the image height (designated by “H” on the drawings).

### First Example of Numerical Values

Following is a first exemplary set of numerical values for the imaging optical system corresponding to the first embodiment shown in FIG. 1A. Specifically, as the first example of numerical values for the imaging optical system, surface data is shown in Table 1A, aspheric surface data is shown in Table 1B, and various types of data in the infinity in-focus state are shown in Tables 1C-1F.

TABLE 1A
(Surface data)

| Surface No. | r | d | nd | vd | ΘgF |
|---|---|---|---|---|---|
| Object surface | ∞ | | | | |
| 1 | 68.33540 | 1.00000 | 1.69895 | 30.1 | 0.6028 |
| 2 | 52.19320 | 8.11430 | 1.71300 | 53.9 | 0.5442 |
| 3 | 203.07390 | Variable | | | |
| 4 | 61.77170 | 1.00000 | 1.83481 | 42.7 | 0.5647 |
| 5 | 21.63920 | 11.13950 | | | |
| 6* | −111.03420 | 1.51230 | 1.55332 | 71.7 | 0.5398 |
| 7 | 26.51620 | 5.30190 | 1.90110 | 27.1 | 0.6072 |
| 8 | 105.54770 | 5.54610 | | | |
| 9 | −34.42640 | 1.04500 | 1.68960 | 31.1 | 0.6031 |
| 10 | −47.98700 | Variable | | | |
| 11 (Aperture) | ∞ | 1.95000 | | | |
| 12 | 32.87000 | 4.20340 | 1.83400 | 37.3 | 0.5790 |
| 13 | 158.57010 | 0.30000 | | | |
| 14 | 36.72240 | 5.44000 | 1.49700 | 81.6 | 0.5389 |
| 15 | −48.25920 | 1.47520 | | | |
| 16 | −38.31620 | 1.00000 | 1.74951 | 35.3 | 0.5818 |
| 17 | 22.57500 | 4.41560 | 1.49700 | 81.6 | 0.5389 |
| 18 | 90.94350 | Variable | | | |
| 19 | 26.91730 | 7.13640 | 1.55032 | 75.5 | 0.5401 |
| 20 | −40.97870 | 0.30000 | | | |
| 21* | 101.83500 | 1.18300 | 1.69350 | 53.2 | 0.5482 |
| 22* | 55.69330 | Variable | | | |
| 23* | 69.00380 | 1.44010 | 1.81055 | 41.1 | 0.5690 |
| 24* | 33.23450 | 12.00310 | | | |
| 25 | −16.12390 | 1.00000 | 1.48749 | 70.4 | 0.5306 |
| 26 | −23.46450 | Variable | | | |
| 27 | −117.06070 | 2.89820 | 1.49700 | 81.6 | 0.5389 |
| 28 | −329.67380 | 0.30000 | | | |
| 29 | 158.46070 | 5.48700 | 1.92119 | 24.0 | 0.6202 |
| 30 | −162.97620 | Variable | | | |
| 31 | ∞ | 1.80000 | 1.51680 | 64.2 | 0.5343 |
| 32 | ∞ | 1.00000 | | | |
| Image plane | ∞ | | | | |

TABLE 1B
(Aspheric surface data)

6^{th} surface
K = 0.00000E+00, A4 = 1.65418E−06, A6 = 2.35613E−09,
A8 = −6.17277E−12 A10 = 1.77861E−14, A12 = 0.00000E+00
21^{st} surface
K = 0.00000E+00, A4 = −7.15927E−06, A6 = −9.60538E−08,
A8 = 2.44811E−10 A10 = −8.38030E−14, A12 = 0.00000E+00
22^{nd} surface
K = 0.00000E+00, A4 = 1.63430E−05, A6 = −6.55930E−08,
A8 = 2.59214E−10 A10 = 2.75345E−13, A12 = 0.00000E+00
23^{rd} surface
K = 0.00000E+00, A4 = −3.27630E−06, A6 = 1.66759E−07,
A8 = −1.98459E−10 A10 = −3.44918E−13, A12 = 2.38114E−15
24^{th} surface
K = 0.00000E+00, A4 = −9.87207E−06, A6 = 1.59487E−07,
A8 = −1.15095E−11 A10 = −1.39913E−12, A12 = 5.93558E−15

TABLE 1C
(Various types of data)
(Zoom ratio: 2.69085)

| | Wide-angle | Middle | Telephoto |
|---|---|---|---|
| Focal length | 36.0455 | 59.1290 | 96.9931 |
| F number | 4.11984 | 4.11992 | 4.11983 |
| Angle of view | 38.1948 | 24.9661 | 15.7173 |
| Image height | 27.5000 | 27.5000 | 27.5000 |
| Total lens length | 150.4098 | 164.4459 | 189.9700 |
| d3 | 1.2133 | 15.2146 | 31.0268 |
| d10 | 28.0712 | 14.5482 | 5.6396 |
| d18 | 5.9766 | 3.4487 | 2.2896 |
| d22 | 3.3108 | 2.2530 | 1.8554 |
| d26 | 6.5833 | 13.0003 | 27.7508 |
| d30 | 17.2633 | 27.9899 | 33.4165 |
| Entrance pupil position | 37.6444 | 58.4850 | 90.0938 |
| Exit pupil position | −87.1151 | −108.4367 | −162.6349 |
| Anterior principal point | 58.7871 | 85.3818 | 129.2237 |
| Posterior principal point | 114.4324 | 105.3505 | 92.9264 |

TABLE 1D
(Data about single lenses)

| Lens | Start surface | Focal length |
|---|---|---|
| 1 | 1 | −324.3870 |
| 2 | 2 | 96.3675 |
| 3 | 4 | −40.3553 |
| 4 | 6 | −38.5330 |
| 5 | 7 | 38.0883 |
| 6 | 9 | −182.3974 |
| 7 | 12 | 48.9739 |
| 8 | 14 | 42.8708 |
| 9 | 16 | −18.8207 |
| 10 | 17 | 59.1528 |
| 11 | 19 | 30.6649 |
| 12 | 21 | −179.1199 |
| 13 | 23 | −80.5512 |
| 14 | 25 | −110.6675 |
| 15 | 27 | −366.8778 |
| 16 | 29 | 87.9368 |

TABLE 1E
(Data about zoom lens groups)

| | | | Lens | Anterior | Posterior |
|---|---|---|---|---|---|
| | Start | Focal | configuration | principal | principal |
| Group | surface | length | length | point | point |
| 1 | 1 | 139.26679 | 9.11430 | −2.58158 | 1.35187 |
| 2 | 4 | −29.96265 | 25.54480 | 4.49970 | 10.15475 |
| 3 | 12 | 67.93943 | 16.83420 | −12.56341 | −2.64530 |
| 4 | 19 | 35.85333 | 8.61940 | 0.94607 | 3.92484 |
| 5 | 23 | −44.36713 | 14.44320 | 5.45330 | 6.84847 |
| 6 | 27 | 113.72847 | 8.68520 | 5.05321 | 8.69302 |

TABLE 1F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 4 | −0.31267 | −0.36617 | −0.45388 |
| 3 | 12 | −29.67497 | 7.05458 | 4.26990 |
| 4 | 19 | 0.01714 | −0.08934 | −0.16995 |
| 5 | 23 | 1.96427 | 2.50498 | 3.07595 |
| 6 | 27 | 0.82845 | 0.73443 | 0.68746 |

### Second Example of Numerical Values

Following is a second exemplary set of numerical values for the imaging optical system corresponding to the second embodiment shown in FIG. 2A. Specifically, as the second example of numerical values for the imaging optical system, surface data is shown in Table 2A, aspheric surface data is shown in Table 2B, and various types of data in the infinity in-focus state are shown in Tables 2C-2F.

TABLE 2A
(Surface data)

| Surface No. | r | d | nd | vd | ΘgF |
|---|---|---|---|---|---|
| Object surface | ∞ | | | | |
| 1 | 65.23670 | 1.00000 | 1.69895 | 30.1 | 0.6028 |
| 2 | 56.60000 | 6.75650 | 1.67790 | 55.3 | 0.5434 |
| 3 | 196.17120 | Variable | | | |
| 4 | 64.69750 | 1.00000 | 1.80420 | 46.5 | 0.5573 |
| 5 | 21.63270 | 10.83010 | | | |
| 6* | −150.64320 | 1.30000 | 1.55032 | 75.5 | 0.5401 |
| 7 | 24.61880 | 5.46990 | 1.90366 | 31.3 | 0.5948 |
| 8 | 80.50070 | 6.68610 | | | |
| 9 | −32.53260 | 1.05400 | 1.65412 | 39.7 | 0.5737 |
| 10 | −42.38930 | Variable | | | |
| 11 (Aperture) | ∞ | 1.51420 | | | |
| 12 | 31.78970 | 4.38350 | 1.80610 | 33.3 | 0.5884 |
| 13 | 154.23990 | 0.61720 | | | |
| 14 | 38.28680 | 4.98850 | 1.48071 | 85.3 | 0.5362 |
| 15 | −50.40560 | 1.53860 | | | |
| 16 | −39.84250 | 1.00000 | 1.73800 | 32.3 | 0.5900 |
| 17 | 22.93020 | 6.55820 | 1.49700 | 81.6 | 0.5389 |
| 18 | 83.75100 | Variable | | | |
| 19 | 25.80210 | 6.91760 | 1.55397 | 71.8 | 0.5392 |
| 20 | −44.39380 | 0.30000 | | | |
| 21* | 329.91120 | 1.00000 | 1.69350 | 53.2 | 0.5482 |
| 22* | 88.12460 | Variable | | | |
| 23* | 97.37870 | 1.51650 | 1.78590 | 43.9 | 0.5612 |
| 24* | 41.06630 | 11.90690 | | | |
| 25 | −17.46520 | 1.00000 | 1.51823 | 59.0 | 0.5442 |
| 26 | −26.51840 | Variable | | | |
| 27 | −759.04430 | 4.24880 | 1.53775 | 74.7 | 0.5392 |
| 28 | 107.17240 | 6.41800 | 1.92119 | 24.0 | 0.6202 |
| 29 | −162.14370 | Variable | | | |
| 30 | ∞ | 1.80000 | 1.51680 | 64.2 | 0.5343 |
| 31 | ∞ | 1.00000 | | | |
| Image plane | ∞ | | | | |

TABLE 2B
(Aspheric surface data)

6^{th} surface
K = 0.00000E+00, A4 = 1.21134E−06, A6 = 3.01137E−09,
A8 = −7.21597E−12 A10 = 2.18986E−14, A12 = 0.00000E+00
21^{st} surface
K = 0.00000E+00, A4 = 1.04425E−05, A6 = −6.72768E−08,
A8 = −1.97410E−10 A10 = 8.63866E−13, A12 = 0.00000E+00
22^{nd} surface
K = 0.00000E+00, A4 = 3.44909E−05, A6 = −2.88964E−08,
A8 = −2.15446E−10 A10 = 1.21806E−12, A12 = 0.00000E+00
23^{rd} surface
K = 0.00000E+00, A4 = 2.46392E−05, A6 = −2.37704E−08,
A8 = 7.03553E−10 A10 = −3.36243E−12, A12 = 7.01117E−15
24^{th} surface
K = 0.00000E+00, A4 = 2.14544E−05, A6 = −3.94060E−08,
A8 = 9.85168E−10 A10 = −4.82209E−12, A12 = 1.09432E−14

(Various Types of Data in Infinity in-Focus State)

TABLE 2C
(Various types of data)
(Zoom ratio: 2.69110)

| | Wide-angle | Middle | Telephoto |
|---|---|---|---|
| Focal length | 36.0408 | 59.1258 | 96.9894 |
| F number | 4.11907 | 4.11948 | 4.12000 |
| Angle of view | 38.4782 | 24.9898 | 15.6901 |
| Image height | 27.5000 | 27.5000 | 27.5000 |
| Total lens length | 153.5989 | 166.5498 | 189.9600 |
| d3 | 1.0000 | 15.5580 | 29.0750 |
| d10 | 29.9083 | 15.0525 | 4.9096 |
| d18 | 5.0005 | 2.8734 | 1.7798 |
| d22 | 2.3475 | 1.6063 | 1.7583 |
| d26 | 7.3107 | 13.4966 | 30.6737 |
| d30 | 17.2269 | 27.1581 | 30.9585 |
| Entrance pupil position | 37.2815 | 58.3731 | 82.2774 |
| Exit pupil position | −88.2249 | −108.7980 | −171.4573 |
| Anterior principal point | 58.6098 | 85.3750 | 124.3781 |
| Posterior principal point | 117.6211 | 107.4502 | 92.8947 |

TABLE 2D
(Data about single lenses)

| Lens | Start surface | Focal length |
|---|---|---|
| 1 | 1 | −642.2605 |
| 2 | 2 | 115.1008 |
| 3 | 4 | −40.8349 |
| 4 | 6 | −38.3503 |
| 5 | 7 | 37.5030 |
| 6 | 9 | −223.3333 |
| 7 | 12 | 48.8934 |
| 8 | 14 | 46.1065 |
| 9 | 16 | −19.5884 |
| 10 | 17 | 61.3361 |
| 11 | 19 | 30.5290 |
| 12 | 21 | −173.6808 |
| 13 | 23 | −91.4444 |
| 14 | 25 | −102.5858 |
| 15 | 27 | −174.3407 |
| 16 | 28 | 70.8538 |

TABLE 2E
(Data about zoom lens groups)

| | | | Lens | Anterior | Posterior |
|---|---|---|---|---|---|
| | Start | Focal | configuration | principal | principal |
| Group | surface | length | length | point | point |
| 1 | 1 | 141.75183 | 7.75650 | −2.29227 | 0.95793 |
| 2 | 4 | −31.43545 | 26.34010 | 4.42993 | 10.03925 |
| 3 | 12 | 70.71889 | 19.08600 | −14.35543 | −3.27707 |
| 4 | 19 | 36.02684 | 8.21760 | 0.86097 | 3.68349 |
| 5 | 23 | −45.98707 | 14.42340 | 5.95077 | 7.40975 |
| 6 | 27 | 117.45130 | 10.66680 | 5.21184 | 9.76815 |

TABLE 2F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 4 | −0.32048 | −0.37634 | −0.44900 |
| 3 | 12 | −26.73900 | 6.76400 | 3.86145 |
| 4 | 19 | 0.01831 | −0.09025 | −0.18681 |
| 5 | 23 | 1.96089 | 2.44610 | 2.97206 |
| 6 | 27 | 0.82652 | 0.74228 | 0.71079 |

### Third Example of Numerical Values

Following is a third exemplary set of numerical values for the imaging optical system corresponding to the third embodiment shown in FIG. 3A. Specifically, as the third example of numerical values for the imaging optical system, surface data is shown in Table 3A, aspheric surface data is shown in Table 3B, and various types of data in the infinity in-focus state are shown in Tables 3C-3F.

TABLE 3A
(Surface data)

| Surface No. | r | d | nd | vd | ΘgF |
|---|---|---|---|---|---|
| Object surface | ∞ | | | | |
| 1 | 70.22080 | 1.20000 | 1.71736 | 29.5 | 0.6040 |
| 2 | 56.37810 | 7.74670 | 1.61997 | 63.9 | 0.5426 |
| 3 | 310.12240 | Variable | | | |
| 4 | 59.18530 | 1.20000 | 1.77250 | 49.6 | 0.5504 |
| 5 | 21.45970 | 10.65510 | | | |
| 6* | −84.18400 | 1.20900 | 1.59522 | 67.7 | 0.5442 |
| 7 | 25.38940 | 5.83960 | 1.90110 | 27.1 | 0.6072 |
| 8 | 109.57310 | 7.47580 | | | |
| 9 | −27.55880 | 1.10220 | 1.85883 | 30.0 | 0.5979 |
| 10 | −34.14760 | Variable | | | |
| 11 (Aperture) | ∞ | 1.95000 | | | |
| 12 | 29.61560 | 4.74000 | 1.83400 | 37.3 | 0.5790 |
| 13 | 173.50610 | 1.49150 | | | |
| 14 | 32.83960 | 5.77650 | 1.48071 | 85.3 | 0.5362 |
| 15 | −49.54460 | 0.94920 | | | |
| 16 | −41.96250 | 1.10000 | 1.80610 | 33.3 | 0.5884 |
| 17 | 19.53310 | 5.04800 | 1.49700 | 81.6 | 0.5389 |
| 18 | 151.81360 | Variable | | | |
| 19* | 32.37300 | 1.80000 | 1.58913 | 61.3 | 0.5374 |
| 20* | 26.46100 | 1.54860 | | | |
| 21 | 43.27560 | 5.93590 | 1.59410 | 60.5 | 0.5552 |
| 22 | −31.52090 | Variable | | | |
| 23* | 44.06500 | 2.40000 | 1.51742 | 52.1 | 0.5590 |
| 24* | 22.85170 | 11.41190 | | | |
| 25 | −17.77980 | 1.10000 | 1.65412 | 39.7 | 0.5737 |
| 26 | −25.86070 | Variable | | | |
| 27 | −399.82650 | 1.40000 | 1.49700 | 81.6 | 0.5389 |
| 28 | 156.11760 | 0.60480 | | | |
| 29 | 129.42900 | 6.41460 | 1.92286 | 20.9 | 0.6390 |
| 30 | −164.81960 | Variable | | | |
| 31 | ∞ | 1.80000 | 1.51680 | 64.2 | 0.5343 |
| 32 | ∞ | 1.00000 | | | |
| Image plane | ∞ | | | | |

TABLE 3B
(Aspheric surface data)

6^{th} surface
K = 0.00000E+00, A4 = 1.72279E−06, A6 = 2.79186E−09,
A8 = −8.36623E−12 A10 = 2.98422E−14, A12 = 0.00000E+00
19^{th} surface
K = 0.00000E+00, A4 = −6.59969E−05, A6 = −1.88243E−07,
A8 = 1.59662E−09 A10 = −1.35900E−12, A12 = −6.56008E−15
20^{th} surface
K = 0.00000E+00, A4 = −4.81652E−05, A6 = −1.94906E−07,
A8 = 2.06212E−09 A10 = −4.62436E−12, A12 = 0.00000E+00
23^{rd} surface
K = 0.00000E+00, A4 = −1.08239E−05, A6 = 1.81885E−07,
A8 = −3.21931E−10 A10 = 7.64378E−13, A12 = −1.67905E−15
24^{th} surface
K = 0.00000E+00, A4 = −2.42718E−05, A6 = 1.87934E−07,
A8 = −2.63574E−10 A10 = 6.52787E−13, A12 = −4.20668E−17

(Various Types of Data in Infinity in-Focus State)

TABLE 3C
(Various types of data)
(Zoom ratio: 2.69076)

| | Wide-angle | Middle | Telephoto |
|---|---|---|---|
| Focal length | 36.0490 | 59.1337 | 96.9991 |
| F number | 4.12016 | 4.11997 | 4.12001 |
| Angle of view | 38.4736 | 24.7131 | 15.5336 |
| Image height | 27.5000 | 27.5000 | 27.5000 |
| Total lens length | 152.3625 | 168.3296 | 189.9700 |
| d3 | 1.0000 | 18.5819 | 30.8626 |
| d10 | 24.8492 | 11.5617 | 1.8361 |
| d18 | 4.5641 | 2.4660 | 1.5000 |
| d22 | 1.5024 | 2.3419 | 4.1206 |
| d26 | 10.5041 | 16.6542 | 33.6712 |
| d30 | 17.0426 | 23.8239 | 25.0795 |
| Entrance pupil position | 36.6347 | 63.0895 | 83.6421 |
| Exit pupil position | −97.2859 | −116.0608 | −182.9796 |
| Anterior principal point | 59.3308 | 92.0978 | 129.2046 |
| Posterior principal point | 116.3492 | 109.2092 | 92.9118 |

TABLE 3D
(Data about single lenses)

| Lens | Start surface | Focal length |
|---|---|---|
| 1 | 1 | −413.6524 |
| 2 | 2 | 109.8587 |
| 3 | 4 | −44.1942 |
| 4 | 6 | −32.6374 |
| 5 | 7 | 35.5063 |
| 6 | 9 | −180.2352 |
| 7 | 12 | 42.1871 |
| 8 | 14 | 42.0405 |
| 9 | 16 | −16.4039 |
| 10 | 17 | 44.5414 |
| 11 | 19 | −277.2412 |
| 12 | 21 | 31.6329 |
| 13 | 23 | −95.4216 |
| 14 | 25 | −91.9357 |
| 15 | 27 | −225.7228 |
| 16 | 29 | 79.3886 |

TABLE 3E
(Data about zoom lens groups)

| | | | Lens | Anterior | Posterior |
|---|---|---|---|---|---|
| | Start | Focal | configuration | principal | principal |
| Group | surface | length | length | point | point |
| 1 | 1 | 151.58354 | 8.94670 | −1.84557 | 1.70280 |
| 2 | 4 | −28.64718 | 27.48170 | 5.64351 | 11.69491 |
| 3 | 12 | 57.07889 | 19.10530 | −11.35209 | −0.51001 |
| 4 | 19 | 35.99221 | 9.28450 | 4.77732 | 7.41479 |
| 5 | 23 | −44.88423 | 14.91190 | 7.36853 | 8.85572 |
| 6 | 27 | 120.52257 | 8.41940 | 4.23977 | 7.78585 |

TABLE 3F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 4 | −0.26270 | −0.31320 | −0.36177 |
| 3 | 12 | 6.81310 | 16.48200 | 4.83833 |
| 4 | 19 | 0.07980 | −0.04106 | −0.17063 |
| 5 | 23 | 1.99444 | 2.36305 | 2.78619 |
| 6 | 27 | 0.83489 | 0.77881 | 0.76900 |

### Fourth Example of Numerical Values

Following is a fourth exemplary set of numerical values for the imaging optical system corresponding to the fourth embodiment shown in FIG. 4A. Specifically, as the fourth example of numerical values for the imaging optical system, surface data is shown in Table 4A, aspheric surface data is shown in Table 4B, and various types of data in the infinity in-focus state are shown in Tables 4C-4F.

TABLE 4A
(Surface data)

| Surface No. | r | d | nd | vd | ΘgF |
|---|---|---|---|---|---|
| Object surface | ∞ | | | | |
| 1 | 69.66960 | 1.20000 | 1.84666 | 23.8 | 0.6192 |
| 2 | 60.89710 | 7.24470 | 1.60300 | 65.4 | 0.5401 |
| 3 | 319.22350 | Variable | | | |
| 4 | 50.43900 | 1.20000 | 1.75700 | 47.8 | 0.5565 |
| 5 | 20.95100 | 10.87310 | | | |
| 6* | −74.24630 | 1.20000 | 1.59282 | 68.6 | 0.5440 |
| 7 | 24.52520 | 5.84880 | 1.85451 | 25.2 | 0.6103 |
| 8 | 108.67750 | 7.51440 | | | |
| 9 | −27.11370 | 1.13820 | 1.85896 | 22.7 | 0.6284 |
| 10 | −33.86710 | Variable | | | |
| 11 (Aperture) | ∞ | 1.95000 | | | |
| 12 | 29.92820 | 4.54310 | 1.79360 | 37.1 | 0.5828 |
| 13 | 168.56510 | 0.98680 | | | |
| 14 | 32.14470 | 5.81000 | 1.49700 | 81.6 | 0.5389 |
| 15 | −46.85350 | 0.70000 | | | |
| 16 | −41.89790 | 1.10000 | 1.76634 | 35.8 | 0.5792 |
| 17 | 18.06420 | 5.19220 | 1.55032 | 75.5 | 0.5401 |
| 18 | 95.28780 | Variable | | | |
| 19* | 35.26310 | 1.80000 | 1.58313 | 59.5 | 0.5405 |
| 20* | 28.37100 | 1.89560 | | | |
| 21 | 44.23910 | 5.93020 | 1.59282 | 68.6 | 0.5440 |
| 22 | −31.90170 | Variable | | | |
| 23* | 41.86300 | 2.40000 | 1.54814 | 45.8 | 0.5700 |
| 24* | 22.40810 | 11.52360 | | | |
| 25 | −17.53480 | 1.10000 | 1.71700 | 47.9 | 0.5557 |
| 26 | −24.71080 | Variable | | | |
| 27 | −430.53610 | 1.43700 | 1.49700 | 81.6 | 0.5389 |
| 28 | 117.41060 | 6.84760 | 1.96300 | 24.1 | 0.6390 |
| 29 | −157.31790 | Variable | | | |
| 30 | ∞ | 1.80000 | 1.51680 | 64.2 | 0.5343 |
| 31 | ∞ | 1.00000 | | | |
| Image plane | ∞ | | | | |

TABLE 4B
(Aspheric surface data)

6^{th} surface
K = 0.00000E+00, A4 = 2.21934E−06, A6 = 1.91303E−09,
A8 = −5.63345E−12 A10 = 2.59893E−14, A12 = 0.00000E+00
19^{th} surface
K = 0.00000E+00, A4 = −6.01713E−05, A6 = −1.67972E−07,
A8 = 1.53081E−09 A10 = −1.80043E−12, A12 = −5.73727E−15
20^{th} surface
K = 0.00000E+00, A4 = −3.98147E−05, A6 = −1.69363E−07,
A8 = 1.88884E−09 A10 = −4.49408E−12, A12 = 0.00000E+00
23^{rd} surface
K = 0.00000E+00, A4 = −1.45191E−05, A6 = 1.91284E−07,
A8 = −2.81320E−10 A10 = 2.70352E−13, A12 = 6.19268E−16
24^{th} surface
K = 0.00000E+00, A4 = −2.85137E−05, A6 = 1.98251E−07,
A8 = −2.51667E−10 A10 = 3.75128E−13, A12 = 4.19724E−16

(Various Types of Data in Infinity in-Focus State)

TABLE 4C
(Various types of data)
(Zoom ratio: 2.69101)

| | Wide-angle | Middle | Telephoto |
|---|---|---|---|
| Focal length | 36.0444 | 59.1298 | 96.9960 |
| F number | 4.11976 | 4.11966 | 4.11998 |
| Angle of view | 38.4772 | 24.7026 | 15.5338 |
| Image height | 27.5000 | 27.5000 | 27.5000 |
| Total lens length | 150.0833 | 167.0568 | 189.9600 |
| d3 | 1.0000 | 19.7316 | 32.2577 |
| d10 | 22.5697 | 9.5843 | 0.4677 |
| d18 | 4.6266 | 2.5154 | 1.6339 |
| d22 | 1.5056 | 2.7028 | 4.7131 |
| d26 | 11.2321 | 15.8518 | 33.1182 |
| d29 | 16.9135 | 24.4352 | 25.5335 |
| Entrance pupil position | 36.0714 | 63.9619 | 84.7674 |
| Exit pupil position | −99.5590 | −115.6880 | −190.1240 |
| Anterior principal point | 59.0696 | 92.8722 | 132.2677 |
| Posterior principal point | 114.0640 | 107.9364 | 92.9209 |

TABLE 4D
(Data about single lenses)

| Lens | Start surface | Focal length |
|---|---|---|
| 1 | 1 | −609.4449 |
| 2 | 2 | 123.4943 |
| 3 | 4 | −48.1852 |
| 4 | 6 | −30.9578 |
| 5 | 7 | 35.9155 |
| 6 | 9 | −171.6657 |
| 7 | 12 | 45.1977 |
| 8 | 14 | 39.3202 |
| 9 | 16 | −16.3406 |
| 10 | 17 | 39.5590 |
| 11 | 19 | −275.4262 |
| 12 | 21 | 32.1997 |
| 13 | 23 | −91.9837 |
| 14 | 25 | −89.9733 |
| 15 | 27 | −185.4584 |
| 16 | 28 | 70.6803 |

TABLE 4E
(Data about zoom lens groups)

| | | | Lens | Anterior | Posterior |
|---|---|---|---|---|---|
| | Start | Focal | configuration | principal | principal |
| Group | surface | length | length | point | point |
| 1 | 1 | 156.77062 | 8.44470 | −1.94189 | 1.40892 |
| 2 | 4 | −28.00033 | 27.77450 | 6.47064 | 12.52690 |
| 3 | 12 | 54.00256 | 18.33210 | −8.67840 | 1.14756 |
| 4 | 19 | 36.62137 | 9.62580 | 5.23646 | 7.87903 |
| 5 | 23 | −43.57185 | 15.02360 | 7.35461 | 8.88469 |
| 6 | 27 | 112.52416 | 8.28460 | 3.48352 | 7.30276 |

TABLE 4F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 4 | −0.24505 | −0.29310 | −0.33733 |
| 3 | 12 | −5.40125 | 32.89088 | 5.67253 |
| 4 | 19 | 0.10365 | −0.02139 | −0.15151 |
| 5 | 23 | 2.04051 | 2.42450 | 2.86346 |
| 6 | 27 | 0.82130 | 0.75460 | 0.74530 |

### Fifth Example of Numerical Values

Following is a fifth exemplary set of numerical values for the imaging optical system corresponding to the fifth embodiment shown in FIG. 5A. Specifically, as the fifth example of numerical values for the imaging optical system, surface data is shown in Table 5A, aspheric surface data is shown in Table 5B, and various types of data in the infinity in-focus state are shown in Tables 5C-5F.

TABLE 5A
(Surface data)

| Surface No. | r | d | nd | vd | ΘgF |
|---|---|---|---|---|---|
| Object surface | ∞ | | | | |
| 1 | 66.12760 | 1.00000 | 1.67270 | 32.2 | 0.5963 |
| 2 | 54.54890 | 7.31560 | 1.65160 | 58.5 | 0.5390 |
| 3 | 201.93410 | Variable | | | |
| 4 | 64.90660 | 1.00000 | 1.77250 | 49.6 | 0.5504 |
| 5 | 22.25610 | 11.51590 | | | |
| 6* | −111.49280 | 1.30220 | 1.59410 | 60.5 | 0.5552 |
| 7 | 26.04880 | 5.91880 | 1.90110 | 27.1 | 0.6072 |
| 8 | 106.84540 | 8.25670 | | | |
| 9 | −29.00300 | 1.31260 | 1.78472 | 25.7 | 0.6161 |
| 10 | −37.06510 | Variable | | | |
| 11 (Aperture) | ∞ | 1.00000 | | | |
| 12 | 36.43040 | 4.12880 | 1.85026 | 32.3 | 0.5980 |
| 13 | 235.20720 | 0.30000 | | | |
| 14 | 41.02180 | 5.39620 | 1.49700 | 81.6 | 0.5389 |
| 15 | −46.90520 | 1.45070 | | | |
| 16 | −38.19560 | 1.00000 | 1.73800 | 32.3 | 0.5900 |
| 17 | 25.07090 | 4.43870 | 1.49700 | 81.6 | 0.5389 |
| 18 | 142.65900 | Variable | | | |
| 19 | 26.88840 | 8.50000 | 1.57144 | 71.6 | 0.5419 |
| 20 | −47.10080 | 0.30000 | | | |
| 21* | 231.37020 | 1.06680 | 1.74320 | 49.3 | 0.5529 |
| 22* | 78.29200 | Variable | | | |
| 23* | 84.76800 | 1.65640 | 1.77200 | 50.0 | 0.5550 |
| 24* | 39.37440 | 12.24910 | | | |
| 25 | −17.39970 | 1.00000 | 1.56883 | 56.0 | 0.5485 |
| 26 | −25.83360 | Variable | | | |
| 27 | −74.94550 | 2.06710 | 1.53775 | 74.7 | 0.5392 |
| 28 | −154.23320 | Variable | | | |
| 29 | 244.37400 | 5.36960 | 1.92286 | 20.9 | 0.6390 |
| 30 | −134.67810 | Variable | | | |
| 31 | ∞ | 1.80000 | 1.51680 | 64.2 | 0.5343 |
| 32 | ∞ | 1.00000 | | | |
| Image plane | ∞ | | | | |

TABLE 5B
(Aspheric surface data)

6^{th} surface
K = 0.00000E+00, A4 = 1.64784E−06, A6 = 2.87775E−09,
A8 = −4.97948E−12 A10 = 1.92071E−14, A12 = 0.00000E+00
21^{st} surface
K = 0.00000E+00, A4 = 1.68154E−05, A6 = −1.10404E−07,
A8 = −1.91961E−11 A10 = 5.40909E−13, A12 = 0.00000E+00
22^{nd} surface
K = 0.00000E+00, A4 = 3.82582E−05, A6 = −7.47593E−08,
A8 = −8.76528E−11 A10 = 1.02249E−12, A12 = 0.00000E+00
23^{rd} surface
K = 0.00000E+00, A4 = 1.76371E−05, A6 = 4.69672E−08,
A8 = 8.22120E−11 A10 = −2.29508E−13, A12 = 1.72982E−15
24^{th} surface
K = 0.00000E+00, A4 = 1.39831E−05, A6 = 2.79755E−08,
A8 = 4.17758E−10 A10 = −2.10853E−12, A12 = 7.43407E−15

(Various Types of Data in Infinity in-Focus State)

TABLE 5C
(Various types of data)
(Zoom ratio: 2.69064)

| | Wide-angle | Middle | Telephoto |
|---|---|---|---|
| Focal length | 36.0503 | 59.1316 | 96.9982 |
| F number | 4.12006 | 4.11999 | 4.11990 |
| Angle of view | 38.4723 | 24.9654 | 15.6905 |
| Image height | 27.5000 | 27.5000 | 27.5000 |
| Total lens length | 151.7299 | 163.9823 | 189.9700 |
| d3 | 1.0000 | 14.2146 | 30.4175 |
| d10 | 25.8837 | 11.4937 | 2.5865 |
| d18 | 7.7347 | 5.0640 | 3.7024 |
| d22 | 1.6329 | 1.8841 | 1.7927 |
| d26 | 8.0268 | 5.3203 | 12.9104 |
| d28 | 0.3000 | 8.5802 | 14.5835 |
| d30 | 16.8063 | 27.0798 | 33.6313 |
| Entrance pupil position | 37.7146 | 55.7567 | 85.6054 |
| Exit pupil position | −84.1725 | −107.7779 | −160.4767 |
| Anterior principal point | 58.3353 | 82.4467 | 123.9552 |
| Posterior principal point | 115.7364 | 104.8523 | 92.9193 |

TABLE 5D
(Data about single lenses)

| Lens | Start surface | Focal length |
|---|---|---|
| 1 | 1 | −479.7778 |
| 2 | 2 | 112.4963 |
| 3 | 4 | −44.2972 |
| 4 | 6 | −35.4169 |
| 5 | 7 | 36.9447 |
| 6 | 9 | −183.0214 |
| 7 | 12 | 50.2194 |
| 8 | 14 | 44.9469 |
| 9 | 16 | −20.3727 |
| 10 | 17 | 60.4426 |
| 11 | 19 | 31.2599 |
| 12 | 21 | −159.6979 |
| 13 | 23 | −96.7821 |
| 14 | 25 | −97.9040 |
| 15 | 27 | −273.5992 |
| 16 | 29 | 94.7284 |

TABLE 5E
(Data about zoom lens groups)

| | | | Lens | Anterior | Posterior |
|---|---|---|---|---|---|
| | Start | Focal | configuration | principal | principal |
| Group | surface | length | length | point | point |
| 1 | 1 | 148.78669 | 8.31560 | −2.44850 | 0.95989 |
| 2 | 4 | −30.01799 | 29.30620 | 5.54470 | 11.90396 |
| 3 | 12 | 64.53751 | 16.71440 | −10.11001 | −1.44490 |
| 4 | 19 | 37.46183 | 9.86680 | 0.92045 | 4.40300 |
| 5 | 23 | −46.28058 | 14.90550 | 6.52506 | 8.05898 |
| 6 | 27 | −273.59919 | 2.06710 | −1.28231 | −0.57182 |
| 7 | 29 | 94.72836 | 5.36960 | 1.81265 | 4.37062 |

TABLE 5F
(Zoom powers of zoom lens groups)

| Group | Start surface | Wide-angle | Middle | Telephoto |
|---|---|---|---|---|
| 1 | 1 | 0.00000 | 0.00000 | 0.00000 |
| 2 | 4 | −0.28624 | −0.32752 | −0.39785 |
| 3 | 12 | −8.90307 | 10.93442 | 5.08243 |
| 4 | 19 | 0.05774 | −0.05957 | −0.14997 |
| 5 | 23 | 1.88104 | 2.26201 | 2.72527 |
| 6 | 27 | 1.11032 | 1.21020 | 1.28918 |
| 7 | 29 | 0.78835 | 0.68048 | 0.61189 |

### (Values Corresponding to Inequalities)

Values, corresponding to the inequalities (1) to (9), of the respective examples of numerical values are shown in the following Table 6:

TABLE 6

| | | 1^{st} example | | 2^{nd} example | | 3^{rd} example | | 4^{th} example | | 5^{th} example | |
|---|---|---|---|---|---|---|---|---|---|---|---|
| | | of numerical | | of numerical | | of numerical | | of numerical | | of numerical | |
| Condition | Inequality | values | | values | | values | | values | | values | |
| (1) | ΔθgF_2p | 0.0077 | | 0.0029 | | 0.0077 | | 0.0073 | | 0.0077 | |
| (2) | νd_2n | 71.72 | | 75.50 | | 67.70 | | 68.62 | | 60.47 | |
| (3) | ΔθgF_3n | −0.0029 | | −0.0001 | | 0.0000 | | −0.0046 | | −0.0001 | |
| (4) | νdp | (L8) | 81.6 | (L8) | 85.3 | (L8) | 85.3 | (L8) | 81.6 | (L8) | 81.6 |
| | | (L10) | 81.6 | (L10) | 81.6 | (L10) | 81.6 | (L10) | 75.5 | (L10) | 81.6 |
| | | (L11) | 75.5 | (L11) | 71.8 | (L12) | 60.5 | (L12) | 68.6 | (L11) | 71.6 |

| | | | | | | |
|---|---|---|---|---|---|---|
| (5) | ΔθgF_Lp | 0.0151 | 0.0151 | 0.0283 | 0.0341 | 0.0283 |
| (6) | BFw/Yw | 0.7296 | 0.7283 | 0.7216 | 0.7169 | 0.7130 |
| (7) | f3/fGRw | 0.5974 | 0.6021 | 0.4736 | 0.4799 | 0.4572 |
| (8) | \|f5/f4\| | 1.2375 | 1.7650 | 1.2470 | 1.1898 | 1.2354 |
| (9) | tGR/tG5 | 0.6013 | 0.7395 | 0.5646 | 0.5514 | 0.5191 |

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

### INDUSTRIAL APPLICABILITY

The imaging optical system according to the present disclosure is applicable to various types of cameras including digital still cameras, lens interchangeable digital cameras, digital camcorders, cameras for cellphones and smartphones, and cameras for personal digital assistants (PDAs), surveillance cameras for surveillance systems, Web cameras, and onboard cameras.

Among other things, the present disclosure is particularly suitably applicable to imaging optical systems that are required to provide high image quality such as digital still camera systems and digital camcorder systems.

1. An imaging optical system consisting of:
a first lens group having positive power;
a second lens group having negative power;
an aperture stop;
a third lens group having positive power;
a fourth lens group having positive power;
a fifth lens group having negative power; and
a rear lens group including one or more lens groups each having power,
the first lens group, the second lens group, the aperture stop, the third lens group, the fourth lens group, the fifth lens group, and the rear lens group being arranged in this order such that the first lens group is located closer to an object than the second lens group, the aperture stop, the third lens group, the fourth lens group, the fifth lens group, or the rear lens group is, and that the rear lens group is located closer to an image plane than the first lens group, the second lens group, the aperture stop, the third lens group, the fourth lens group, or the fifth lens group is,
an interval between two adjacent ones of the first, second, third, fourth, and fifth lens groups and the one or more lens groups of the rear lens group changing while the imaging optical system is zooming from a wide-angle end toward a telephoto end,
the fifth lens group consisting of:
a first negative meniscus lens having a convex surface facing the object; and
a second negative meniscus lens having a convex surface facing the image plane, and
the first negative meniscus lens and the second negative meniscus lens being arranged in this order such that the first negative meniscus lens is located closer to the object than the second negative meniscus lens is and that the second negative meniscus lens is located closer to the image plane than the first negative meniscus lens is, and
the fifth lens group moving in a direction pointing from the object toward the image plane while the imaging optical system is focusing to make a transition from an infinity in-focus state toward a close-object in-focus state.

2. The imaging optical system of claim 1, wherein
the second lens group includes a bonded lens, and
the imaging optical system satisfies the following inequality (1):
$$- 0.002 < Δθ gF\_ 2 p < 0.015 \qquad ( 1 )$$
where ΔθgF_2p is a deviation ΔθgF of a partial dispersion ratio of a positive lens in response to a g-line, the positive lens being one of two lenses that form the bonded lens, and
the deviation ΔθgF is a value determined by the following equation (A):
$$Δθ gF = θ gF - ( 0.648285 - 0.00180123 \times vd ) \qquad ( A )$$
where θgF is the partial dispersion ratio in response to the g-line and vd is an abbe number in response to a d-line.

3. The imaging optical system of claim 1, wherein
the second lens group includes a bonded lens, and
the imaging optical system satisfies the following inequality (2):
$$50 < vd\_ 2 n < 90 \qquad ( 2 )$$
where vd_2n is an abbe number of a negative lens in response to a d-line, the negative lens being one of two lenses that form the bonded lens.

4. The imaging optical system of claim 1, wherein
the third lens group includes a bonded lens, and
the imaging optical system satisfies the following inequality (3):
$$- 0.01 < Δθ gF\_ 3 n < 0.005 \qquad ( 3 )$$
where ΔθgF_3n is a deviation ΔθgF of a partial dispersion ratio of a negative lens in response to a g-line, the negative lens being one of two lenses that form the bonded lens, and
the deviation ΔθgF is a value determined by the following equation (A):
$$Δθ gF = θ gF - ( 0.648285 - 0.00180123 \times ν d ) \qquad ( A )$$
where θgF is the partial dispersion ratio in response to the g-line and vd is an abbe number in response to a d-line.

5. The imaging optical system of claim 1, comprising at least three positive lenses located closer to the image plane than the aperture stop is, wherein
the imaging optical system satisfies the following inequality (4):
$$50 < vdp < 100 \qquad ( 4 )$$
where vdp is an abbe number of each of the at least three positive lenses located closer to the image plane than the aperture stop is.

6. The imaging optical system of claim 1, wherein
a lens located closest to the image plane is a positive lens,
the imaging optical system satisfies the following inequality (5):
$$0.012 < Δθ gF\_Lp < 0.04 \qquad ( 5 )$$
where ΔθgF_Lp is a deviation ΔθgF of a partial dispersion ratio of the positive lens located closest to the image plane in response to a g-line, and
the deviation ΔθgF is a value determined by the following equation (A):
$$Δθ gF = θ gF - ( 0.648285 - 0.00180123 \times vd ) \qquad ( A )$$
where θgF is the partial dispersion ratio in response to the g-line and vd is an abbe number in response to a d-line.

7. The imaging optical system of claim 1, wherein
the imaging optical system satisfies the following inequality (6):
$$0.5 < BFw / Yw < 1. \qquad ( 6 )$$
where BFw is a distance from a lens located closest to the image plane to the image plane at the wide-angle end, and
Yw is a maximum image height at the wide-angle end.

8. The imaging optical system of claim 1, wherein
the imaging optical system satisfies the following inequality (7):
$$0. < f 3 < fGRw < 1. \qquad ( 7 )$$
where f3 is a focal length of the third lens group, and
fGRw is a focal length of the rear lens group at the wide-angle end.

9. The imaging optical system of claim 1, wherein
the imaging optical system satisfies the following inequality (8):
$$0.5 < \vert f 5 / f 4 \vert < 2. \qquad ( 8 )$$
where f4 is a focal length of the fourth lens group, and
f5 is a focal length of the fifth lens group.

10. The imaging optical system of claim 1, wherein
the imaging optical system satisfies the following inequality (9):
$$0.2 < tGR / tG 5 < 1. \qquad ( 9 )$$
where tG5 is a length of the fifth lens group on an optical axis, and
tGR is a length on the optical axis from an object-side surface of a lens located closest to the object in the rear lens group to an image-side surface of a lens located closest to the image plane in the rear lens group at the wide-angle end.

11. A camera system comprising:
an interchangeable lens unit including the imaging optical system of claim 1; and
a camera body including: an image sensor configured to receive an optical image of an object formed by the imaging optical system and transform the optical image into an electrical image signal; and a camera mount, the camera body being configured to be connected removably to the interchangeable lens unit via the camera mount,
the interchangeable lens unit being configured to form the optical image of the object on the image sensor.

12. An image capture device configured to transform an optical image of an object into an electrical image signal and display and/or store the electrical image signal thus transformed, the image capture device comprising:
the imaging optical system of claim 1 configured to form the optical image of the object; and
an image sensor configured to transform the optical image formed by the imaging optical system into the electrical image signal.
